(19) United States
(12) Patent Application Publication
(10) Pub. No.: US 2017/0012277 A1
(43) Pub. Date: Jan. 12, 2017

(54) OPEN FRAMEWORK COMPOSITES, METHODS FOR PRODUCING AND USING SUCH COMPOSITES

(71) Applicant: NIVO SYSTEMS, INC., Culver City, CA (US)

(72) Inventor: Bo WANG, Beijing (CN)

(73) Assignee: Nivo Systems, Inc., Culver City, CA (US)

(21) Appl. No.: 15/115,241

(22) PCT Filed: Feb. 2, 2015
(86) PCT No.: PCT/US15/14080

§ 371 Date: Jul. 28, 2016

Related U.S. Application Data
(60) Provisional application No. 62/073,812, filed on Oct. 31, 2014.
(60) Provisional application No. 61/935,668, filed on Feb. 4, 2014.

(51) Int. Cl. H01M 4/36; H01M 4/66; H01M 4/134; H01M 4/1397; H01M 4/58; H01M 4/38; H01M 4/1395; H01M 10/0525; H01M 4/136

(52) U.S. Cl. CPC H01M 4/362; H01M 10/0525; H01M 4/663; H01M 4/134; H01M 4/136; H01M 4/5815; H01M 4/386; H01M 4/387; H01M 4/1395; H01M 4/1397

(57) ABSTRACT

Provided herein are composites made up of open frameworks encapsulating sulfur, silicon and tin, and mechanochemical methods of producing such composites. Such open frameworks may include metal-organic frameworks (MOFs), including for example zeolitic imidazolate frameworks (ZIFs), and covalent organic frameworks (COFs). Such composites may be suitable for use as electrode materials, or more specifically for use in batteries. For example, sulfur composites may be used as cathode materials in Li-ion batteries; and silicon or tin composites may be used as anode materials in Li-ion batteries.

### CROSS-REFERENCE TO RELATED APPLICATIONS

This application claims priority to U.S. Provisional Patent Application No. 61/935,668, filed Feb. 4, 2014, and U.S. Provisional Patent Application No. 62/073,812, filed Oct. 31, 2014, which are incorporated herein by reference in their entireties.

### FIELD

The present disclosure relates generally to open framework composites, and more specifically to composites with open frameworks, such as metal-organic frameworks (including zeolitic imidazolate frameworks) and covalent organic frameworks, encapsulating, for example, sulfur, silicon or tin, suitable for use in batteries.

### BACKGROUND

Rechargeable lithium-ion batteries are often used in portable wireless devices, such as mobile phones, laptops and digital cameras. However, the energy densities of current lithium-ion batteries have been found insufficient to power electric vehicles (EVs). As a result, lithium-ion batteries are typically used in stationary electricity storage.

Sulfur can serve as a cathode material in batteries. Lithium-sulfur (Li—S) batteries have the potential to satisfy the growing demands for portable wireless devices and electric vehicles. Li—S batteries have a theoretical capacity of 1,675 mAh/g, which is more than five times that of conventional lithium-ion batteries based on intercalation electrodes, and a specific energy of 2,600 Wh/kg. Moreover, sulfur is abundant and non-toxic. Despite the above advantages stated above, Li—S batteries face fundamental challenges. For example, the dissolution of polysulfides into the electrolyte of the battery can cause a reaction with the Li anode resulting in active mass loss, or random redeposition at the cathode surface terminating the electrochemical reactions. Thus, there exists a need in the art to produce Li—S batteries with cycle life longer than what is currently achievable in the art.

Silicon or tin, on the other hand, can serve as an anode material in batteries. Developing Li-ion batteries with higher storage capacity, faster charging rate, greater cycling stability, and higher power are desired in the art, for example, for use in next-generation electrical vehicles. For example, silicon has a theoretical specific capacity of 4200 mAh/g, which is ten times that of commercial graphite anodes, and a volumetric capacity of 9786 mAh/cm³. Silicon is considered relatively cheap and environmentally safe. However, conventional silicon anodes typically suffer from poor capacity retention due to mechanical fracture caused by large volume expansion during the alloying reaction of the silicon, limiting their cycle life and application in high-power devices such as electric vehicles. Thus, there also exists a need in the art to produce anodes for Li-ion batteries with cycle life longer than what is currently achievable in the art.

### BRIEF SUMMARY

Provided herein are open framework composites, such as metal-organic framework (MOFs) and covalent organic frameworks (COFs) encapsulating, for example, sulfur, silicon and tin, suitable for use in batteries. Provided herein are also methods for producing such composites, which are made up of porous open framework formed from organic linking moieties bridged by multidentate organic or inorganic cores. As used herein, “core” refers to a repeating unit or units found in a framework. The framework may include a homogenous repeating core or a heterogeneous repeating core structure. A core includes a metal and a linking moiety. A plurality of cores linked together forms a framework.

In one aspect, provided are methods to produce MOF composites that involve mechanochemically processing (i) organic linking compounds, (ii) metal compounds, and (iii) sulfur, silicon or tin to produce composites of open frameworks incorporating sulfur, silicon or tin. The mechanochemical processing may involve grinding or stirring to produce the composites. Additionally, in some embodiments, the methods provided may be “one-pot” methods, in which the formation of open frameworks and the incorporation of the sulfur, silicon or tin in the pores of the open frameworks formed occur in the same step. Thus, in one aspect, provided is a mechanochemical method for producing a composite, by grinding a mixture that includes (i) one or more organic linking compounds, (ii) one or more metal compounds, and (iii) sulfur, silicon or tin to produce the composite. In another aspect, provided is a mechanochemical method for producing a composite, by stirring a mixture that includes (i) one or more organic linking compounds, (ii) one or more metal compounds, and (iii) sulfur, silicon or tin to produce the composite.

In other aspects, the method may involve: (a) mechanochemically processing a mixture of one or more organic linking compounds and one or more metal compounds, then (b) adding sulfur, silicon or tin to the mixture, and (c) mechanochemically processing the mixture to produce the composite. As discussed above, in certain embodiments, the mechanochemically processing may involve grinding or stirring.

The composites produced from the methods described above includes an open framework formed from the one or more organic linking compounds and the one or more metal compounds. The open framework has one or more pores, and the sulfur, silicon or tin occupies at least a portion of the one or more pores. The composites produced from such methods include metal-organic frameworks (MOFs), including, for example, zeolitic imidazolate frameworks (ZIFs). MOFs are porous materials assembled by coordination of metal ions and organic linking compounds. ZIFs are a class of MOFs that are topologically isomorphic with zeolites. ZIFs may be made up of tetrahedrally-coordinated metal ions connected by organic imidazole linkers (or derivatives thereof).

In some embodiments, the methods described above may involve further heating the composite produced from mechanochemically processing. The further heating may carbonize the composite to convert the open framework into amorphous carbon with dispersed metal ions. For example, S/ZIF-8 may undergo pyrolysis to convert ZIF-8 in the composite into amorphous carbon with dispersed zinc ions.

In another aspect, provided are methods to produce COF composites that involve mechanochemically processing (i) organic linking compounds, and (ii) sulfur, silicon or tin to produce composites of open frameworks incorporating sulfur, silicon or tin. The mechanochemical processing may involve grinding or stirring to produce the composites. Additionally, in some embodiments, such methods may be “one-pot” methods, in which the formation of open frameworks and the incorporation of the sulfur, silicon or tin in the pores of the open frameworks formed occur in the same step. Thus, in one aspect, provided is a mechanochemical method for producing a composite, by grinding a mixture that includes (i) one or more organic linking compounds, and (ii) sulfur, silicon or tin to produce the composite. In another aspect, provided is a mechanochemical method for producing a composite, by stirring a mixture that includes (i) one or more organic linking compounds, and (iii) sulfur, silicon or tin to produce the composite.

In other aspects, the method may involve: (a) mechanochemically processing a mixture of one or more organic linking compounds, then (b) adding sulfur, silicon or tin to the mixture, and (c) mechanochemically processing the mixture to produce the composite. As discussed above, in certain embodiments, the mechanochemically processing may involve grinding or stirring.

The composites produced from such methods includes an open framework formed from the one or more organic linking compounds. The open framework has one or more pores, and the sulfur, silicon or tin occupies at least a portion of the one or more pores. The composites produced from such methods include covalent organic frameworks (COFs). COFs are porous materials assembled from organic linking compounds via covalent bonds, and the organic linking compounds are typically made up of light elements, such as hydrogen, boron, carbon, nitrogen and oxygen.

The methods provided herein may produce composites that have an even distribution of the sulfur, silicon or tin in the open frameworks. As discussed in further detail below, even distribution of the sulfur, silicon or tin may be determined by the lack, or low intensity, of the peak corresponding to sulfur, silicon or tin in an X-Ray Powder Diffraction (XRPD) pattern of the composite. Additionally, the methods provided herein may produce composites of certain sizes (particle sizes), which make them suitable for use, for example, as active electrode materials in batteries (e.g., Li-ion batteries) and other applications.

Thus, provided is also an electrode made up of a composite provided herein or produced according to the methods described herein; carbonaceous material; and binder. In some embodiments, the electrode is a cathode, and the composite is a sulfur composite provided herein or produced according to the methods described herein. In other embodiments, the electrode is an anode, and the composite is a silicon or tin composite provided herein or produced according to the methods described herein.

Provided is also a battery made up of any of the electrodes described herein; and lithium ions.

### DESCRIPTION OF THE FIGURES

The present application can be understood by reference to the following description taken in conjunction with the accompanying figures.

FIGS. 1(a)-(d) depict four exemplary MOFs: FIG. 1(a) ZIF-8, FIG. 1(b) HKUST-1, FIG. 1(c) MIL-53 (Al), and FIG. 1(d) NH₂-MIL-53 (Al). The sphere in the middle of a MOF depicts the void space of the MOF.

FIGS. 2(a)-(c) show characterization data related to the four S/MOFs prepared in Example 1. The top row in FIG. 2(a) shows photographs of mixtures of sulfur and control MOFs (S+MOF), and the bottom for in this figure shows photographs of the four composites after grinding and heat treatment (bottom row, S/MOF). From left to right, the photographs relate to ZIF-8, HKUST-1, MIL-53 (Al), and NH₂-MIL-53 (Al). FIG. 2(b) shows X-Ray Powder Diffraction (XRPD) patterns of the S/MOFs formed after grinding and heat treatment in comparison to the XRPD pattern of elemental sulfur. FIG. 2(c) shows scanning electron microscope (SEM) images of NH₂-MIL-53 (Al) (top) and S/NH₂-MIL-53 (Al) (bottom); scale bars: 500 nm.

FIGS. 3(a)-(d) are XRPD patterns of (i) elemental sulfur, (ii) the control MOF, (iii) the mixture of sulfur and control MOF (S+MOF), (iv) and the S/MOF prepared in Example 1 (S/MOF): FIG. 3(a) ZIF-8, FIG. 3(b) HKUST-1, FIG. 3(c) MIL-53 (Al), and FIG. 3(d) NH₂-MIL-53 (Al).

FIGS. 4(a)-(h) are SEM images of (i) the control MOF, and (ii) the S/MOF prepared in Example 1 after grinding and heat treatment: FIG. 4(a) ZIF-8, FIG. 4(b) HKUST-1, FIG. 4(c) MIL-53 (Al), FIG. 4(d) NH2-MIL-53 (Al), FIG. 4(e) S/ZIF-8, FIG. 4(f) S/HKUST-1, FIG. 4(g) S/MIL-53 (Al), and FIG. 4(h) S/NH₂-MIL-53 (Al). Scale bars: 500 nm for FIGS. 4(a), (d), (e), and (h); 3 μm for FIGS. 4(b), (c), (f), and (g).

FIGS. 5(a)-(d) are nitrogen adsorption-desorption isotherms of (i) the control MOF, and (ii) the S/MOF prepared in Example 1 after grinding and heat treatment: FIG. 5(a) ZIF-8, FIG. 5(b) HKUST-1, FIG. 5(c) MIL-53 (Al), and FIG. 5(d) NH2-MIL-53 (Al). Open dots refer to the desorption branch of the isotherms; solid dots refers to adsorption branch.

FIGS. 6(a)-(d) are graphs depicting thermal gravimetric analysis (TGA) measurements for (i) the control MOF, and (ii) the S/MOF prepared in Example 1 after grinding and heat treatment: FIG. 6(a) ZIF-8, FIG. 6(b) HKUST-1, FIG. 6(c) MIL-53 (Al), and FIG. 6(d) NH₂-MIL-53 (Al).

FIGS. 7(a)-(b) show data for long-term cyclabilities of the S/MOFs prepared in Example 1 at 0.5 C. FIG. 7(a) is a graph depicting cycling performance. FIG. 7(b) is a graph depicting average decay rate over 200 cycles.

FIGS. 8(a)-(d) are graphs depicting the discharge/charge profiles (corresponding to ascending and descending curves respectively with respect to increasing specific capacity) of the S/MOFs prepared in Example 1 at 0.5 C over 100 cycles: FIG. 8(a) S/ZIF-8, FIG. 8(b) S/HKUST-1, FIG. 8(c) S/MIL-53 (Al), and FIG. 8(d) S/NH₂-MIL-53 (Al).

FIGS. 9(a)-(b) show data for the rate capabilities of the S/MOFs prepared in Example 1 at various charging rate s (C-rates). FIG. 9(a) is a graph depicting cycling performance. FIG. 9(b) is a graph depicting discharge capacities and overpotentials at 0.1 C (10th cycle), 0.2 C (20th cycle), 0.5 C (30th cycle), 1 C (40th cycle), and returning back to 0.1 C (50th cycle).

FIGS. 10(a)-(d) are graphs depicting the discharge/charge profiles (corresponding to ascending and descending curves respectively with respect to increasing specific capacity) of the four S/MOFs at 0.1 C (10th cycle), 0.2 C (20th cycle), 0.5 C (30th cycle), and 1 C (40th cycle): FIG. 10(a) S/ZIF-8, FIG. 10(b) S/HKUST-1, FIG. 10(c) S/MIL-53 (Al), and FIG. 10(d) S/NH₂-MIL-53 (Al).

FIG. 11 are XRPD patterns of (a) a ZIF-8 control; (b) elemental silicon used in Example 2; (c) the mixture of Si and ZIF-8 used in Example 2 after grinding but before heat treatment (ground Si+ZIF-8); and (d) the Si/ZIF-8 prepared in Example 2 after heat treatment at 700° C. for 1 hour.

FIG. 12 is a graph depicting the cyclic voltammetry of the Si/ZIF-8 prepared in Example 2 after heat treatment at 700° C. for 1 hour.

FIG. 13 is a graph depicting electrochemical impedance spectroscopy of the Si/ZIF-8 prepared in Example 2 after heat treatment at 700° C. for 1 hour.

FIG. 14 is a graph depicting the electrochemical cycle tests of the Si/ZIF-8 prepared in Example 3a.

FIG. 15 is a graph depicting the electrochemical cycle tests of the Si/MOF-5 prepared in Example 3a.

FIG. 16(a) is a SEM image of the Si/ZIF-8 (before carbonization) prepared in Example 3a. FIG. 16(b) is a SEM image of the carbonized Si/ZIF-8 prepared in Example 3. Scale bars: 1 micron.

FIG. 17(a) is a SEM image of the Si/MOF-5 (before carbonization) prepared in Example 3a. FIG. 17(b) is a SEM image of the carbonized Si/MOF-5 prepared in Example 3. Scale bars: 1 micron.

FIG. 18 depicts an exemplary lithium-ion (Li-ion) battery, in which the cathode is made up of S/MOF and the anode is made up of Si/MOF or Sn/MOF. It should be understood that the size of the cathode and anode relative to the battery is not drawn to scale.

FIG. 19 depicts an exemplary process to preparing an anode material with carbonized Si/ZIF-8 for use in a lithium ion battery. It should be understood that the size of the cathode and anode relative to the battery is not drawn to scale.

FIG. 20(a) is a series of PXRD patterns comparing: (i) Si/ZIF-8-700N, which refers to carbonized Si/ZIF-8 prepared by heating the sample at 700° C. under a nitrogen atmosphere for one hour; (ii) Si; (iii) Si/ZIF-8; and (iv) a ZIF-8 control. FIG. 20(b) is an XPS spectrum of Zn 2p for Si/ZIF-8-700N. FIGS. 20(c) and 20(d) are nitrogen sorption isotherms at 77 K for Si-ZIF-8 (before carbonization) and Si/ZIF-8-700N (after carbonization), respectively. The inlets of each graph shows the pore size distribution from NLDFT calculations using the adsorption branches.

FIG. 21(a) is an SEM image of Si/ZIF-8-700N. FIG. 21(b) is a TEM image of Si-ZIF/8, wherein the round balls embedded in the material are Si (50-100 nm). FIG. 21(c) is a TEM image of Si/ZIF-8-700N, showing that after pyrolysis, ZIF-8 converts to amorphous carbon with mono-dispersed zinc ions. FIG. 21(d) is an elemental map of Si/ZIF-8-700N for Zn and Si by energy-dispersive X-ray spectroscopy (EDS), wherein the ZIF composites are dispersed around the Si nanoparticles. FIG. 21(e) is a HRTEM image of Si/ZIF-8-700N, which is an enlarged image of the edge of the particles in the areas indicated by the ovals in FIG. 21(c). FIG. 21(f) is a HRTEM image of Si/ZIF-8-700N, which is an enlarged image of the center of the particles in the areas indicated by the circles in FIG. 21(c).

FIG. 22(a) is a graph depicting the electrochemical cycle tests of Si/ZIF-8-700N prepared according to the procedure in Example 3b. FIG. 22(b) is a graph depicting the discharge/charge profiles (corresponding to ascending and descending curves respectively with respect to increasing specific capacity) of Si/ZIF-8-700N at 1 C, 5 C, 10 C, 20 C and 40 C. FIG. 22(c) is a graph depiciting the cyclic voltammetry of Si/ZIF-8-700N. FIG. 22(d) is a graph depicting the discharge capacity of Si/ZIF-8-700N at various current densities varying from 200 to 3200 mA/g. FIG. 22(e) is a graph depicting the electrochemical impedance of Si/ZIF-8-700N as compared to nano Si after four cycles. FIG. 22(f) is a graph depicting the long cycle performance of Si/ZIF-8-700N at 200 mA/g.

FIG. 23 is a graph depicting the cycle-life performances of (a) Si/ZIF-8-700N, (b) ZIF-8-700N, and (c) pure nano Si.

### DETAILED DESCRIPTION

The following description sets forth exemplary compositions, methods, parameters and the like. It should be recognized, however, that such description is not intended as a limitation on the scope of the present disclosure but is instead provided as a description of exemplary embodiments.

The present disclosure provides composites made up of open frameworks, such as metal-organic frameworks (MOFs) and covalent organic frameworks (COFs) encapsulating sulfur, silicon or tin. It is understood in the art that zeolitic imidazolate frameworks (ZIFs) are a certain class of MOFs. Such composites may be suitable for use as electrode materials in batteries, such as Li-ion batteries, and other applications. In one variation, the composites suitable for use as electrode materials in batteries are MOF composites, including, for example, ZIF composites.

As used herein, “MOF composite” refers to a MOF having one or more pores, wherein sulfur, silicon or tin occupies at least a portion of the one or more pores of the MOF. As used herein, “ZIF composite” refers to a ZIF having one or more pores, wherein sulfur, silicon or tin occupies at least a portion of the one or more pores of the ZIF. As used herein, “COF composite” refers to a composite made up of one or more COF having one or more pores, wherein sulfur, silicon or tin occupies at least a portion of the one or more pores of the COF.

The present disclosure provides mechanochemical methods for producing such composites. In one variation to produce MOF composites, the methods includes mechanochemically processing (i) organic linking compounds, (ii) metal compounds, and (iii) sulfur, silicon or tin to produce open frameworks encapsulating the sulfur, silicon or tin. In another variation to produce COF composites, the methods includes mechanochemically processing (i) organic linking compounds, and (ii) sulfur, silicon or tin to produce open frameworks encapsulating the sulfur, silicon or tin.

As used herein, “mechanochemical processing” refers to the use of mechanical energy to activate chemical reactions and structural changes. Mechanochemical processing may involve, for example, grinding or stirring. Such mechanochemical methods described herein are different from methods known in the art to generally synthesize open framework, which may typically involve hydrothermal and solvothermal synthesis. It should be understood, however, that the mechanochemical methods provided may include one or more subsequent steps after the mechanochemical formation of the open frameworks encapsulating sulfur, silicon or tin.

Such mechanochemical methods described herein may be one-pot methods for producing such composites by forming the open frameworks and encapsulating the sulfur, silicon or tin in the open frameworks in the same step. In one variation to produce MOF composites, the method includes mechanochemically processing (i) the organic linking compounds, (ii) the metal compounds, and (iii) the sulfur, silicon or tin together. In another variation to produce COF composites, the method includes mechanochemically processing (i) the organic linking compounds, and (ii) the sulfur, silicon or tin together. The formation of the open frameworks and the incorporation of the sulfur, tin or silicon into the pores of the open frameworks occur in one step.

The methods provided may be used for any class of open frameworks, including zeolitic imidazolate frameworks (ZIFs) and other metal organic frameworks (MOFs), covalent organic frameworks (COFs), and all possible resulting net topologies (including any net topologies known to one of skill in reticular chemistry).

The sulfur composites may be suitable for use as cathode materials in batteries, such as Li-ion batteries. As used herein, “sulfur composite” refers to an open framework having one or more pores, wherein sulfur occupies at least a portion of the one or more pores of the open framework. A sulfur composite may also be referred to herein as “S/open framework” (e.g., S/MOF, S/ZIF, or S/COF). It should further be understood that “S+open framework” (e.g., S+MOF, S+ZIF, S+COF) refers to a mixture of sulfur and open framework, in which the sulfur and the open framework are separate materials and the sulfur is not encapsulated in the open framework.

The silicon and tin composites may be suitable for use as anode materials in batteries, such as Li-ion batteries. As used herein, “silicon composite” refers an open framework having one or more pores, wherein silicon occupies at least a portion of the one or more pores of the open framework. A silicon composite may also be referred to herein as Si/open framework (e.g., Si/MOF, Si/ZIF, or Si/COF). It should further be understood that “Si+open framework” (e.g., Si+MOF, Si+ZIF, Si+COF) refers to a mixture of silicon and open framework, in which the silicon and the open framework are separate materials and the silicon is not encapsulated in the open framework.

As used herein, “tin composite” refers to an open framework having one or more pores, wherein tin occupies at least a portion of the one or more pores of the open framework. A tin composite may also be referred to herein as Sn/open framework (e.g., Sn/MOF, Sn/ZIF, or Sn/COF). It should further be understood that “Sn+open framework” (e.g., Sn+MOF, Sn+ZIF, Sn+COF) refers to a mixture of tin and open framework, in which the tin and the open framework are separate materials and the tin is not encapsulated in the open framework.

By using the methods provided herein (including the one-pot mechanochemical methods), the sulfur, silicon or tin is more evenly incorporated into the open framework of the composite. Moreover, the methods provided produce composites with sizes (particle sizes) that unexpectedly improve capacity retention and life cycle of the material when used as an electrode material.

The methods for producing such composites, the structure and properties of the composites, and their uses are described in further detail below.

### Methods of Producing the Composites

Provided herein are methods to produce MOF composites that involve mechanochemically processing (i) organic linking compounds, (ii) metal compounds, and (iii) sulfur, silicon or tin. In certain aspects, the methods may be performed in “one-pot”, such that the (i) organic linking compounds, (ii) metal compounds, and (iii) sulfur, silicon or tin are mechanochemically processed together in the same step. The mechanochemical processing may involve grinding or stirring. Thus, in one aspect, provided is a the method that involves grinding a mixture that includes (i) one or more organic linking compounds, (ii) one or more metal compounds, and (iii) sulfur, silicon or tin to produce the MOF composites described herein. In another aspect, provided is a the method that involves stirring a mixture that includes (i) one or more organic linking compounds, (ii) one or more metal compounds, and (iii) sulfur, silicon or tin to produce the MOF composites described herein.

Provided herein are methods to produce COF composites that involve mechanochemically processing (i) organic linking compounds, and (ii) sulfur, silicon or tin. In certain aspects, the methods may be performed in “one-pot”, such that the (i) organic linking compounds, and (ii) sulfur, silicon or tin are mechanochemically processed together in the same step. The mechanochemical processing may involve grinding or stirring. Thus, in one aspect, provided is a the method that involves grinding a mixture that includes (i) one or more organic linking compounds, and (ii) sulfur, silicon or tin to produce the COF composites described herein. In another aspect, provided is a the method that involves stirring a mixture that includes (i) one or more organic linking compounds, and (ii) sulfur, silicon or tin to produce the COF composites described herein.

The mechanochemically processing (e.g., grinding or stirring) may be performed in a liquid medium. Additionally, the mechanochemically processing may be performed without the addition of external heat.

It should generally be understood that when the organic linking compound(s) and sulfur, silicon or tin are mechanochemically processed with metal compounds, MOF composites are produced. Thus, in one variation, the mechanochemically processing yields a composite made up of an open framework formed from the one or more organic linking compounds and the one or more metal compounds. Further, when the organic linking compound(s) and sulfur, silicon or tin are mechanochemically processed, i.e., in the absence of any metal compounds, COF composites are produced. Thus, in another variation, the mechanochemically processing yields a composite made up of an open framework formed from the one or more organic linking compounds. The open framework has one or more pores, and the sulfur, silicon or tin occupies at least a portion of the one or more pores. In some embodiments, the method may further include heating the composite obtained from the mechanochemically processing step. The heating step may help to further improve the distribution of the sulfur, silicon or tin occupying the one or more pores.

Grinding

Any suitable methods and techniques known in the art may be used to grind the (i) organic linking compounds, (ii) metal compounds (present for producing MOF composites; absent for producing COF composites), and (iii) sulfur, silicon or tin. In one embodiment of the method, the grinding may be performed using a ball mill. For example, a high-energy ball mill machine may be used. The frequency of the ball mill machine may vary, and is expressed as the rate at which the mixture will be rotated and/or shaken with the balls of the machine. In one variation of the method, grinding is performed using a ball mill at a frequency of between 5 Hz and 60 Hz, between 10 Hz and 50 Hz, between 10 Hz and 30 Hz, or between 10 Hz and 20 Hz. In another variation, grinding is performed using a ball mill operating between 600 rmp to 1200 rmp.

In the mechanochemical methods, the grinding of (i) organic linking compounds, (ii) metal compounds (present for producing MOF composites; absent for producing COF composites), and (iii) sulfur, silicon or tin may produce intrinsic heat, which may help with the formation of the composite. The intrinsic heat may, for example, cause the reaction to take place a temperature between room temperature and 60° C., between room temperature and 55° C., between room temperature and 50° C., between room temperature and 55° C., between room temperature and 40° C., between room temperature and 45° C., or between room temperature and 30° C.; or at about room temperature. In certain embodiments, the composite is produced at a temperature below 60° C., below 55° C., below 50° C., below 55° C., below 40° C., below 45° C., or below 30° C.; or at about room temperature. In some embodiments of the method, grinding is performed without external heating.

The amount of time used for the grinding also may impact the formation of the composites, including, for example, the distribution of the sulfur, silicon or tin encapsulated in the open frameworks formed from the organic linking compounds and the metal compounds. In some embodiments of the method, the grinding is performed for at least 1 minute, at least 5 minutes, at least 10 minutes, at least 20 minutes, at least 30 minutes, at least 60 minutes, at least 120 minutes, at least 240 minutes, or at least 480 minutes; or between 5 minutes and 1000 minutes, between 5 minutes and 720 minutes, or between 5 minutes and 120 minutes.

The grinding may be performed under inert atmosphere. For example, the grinding of the mixture may be performed in the presence of an inert gas, such as argon or nitrogen. The grinding under inert atmosphere may help reduce the impurities produced.

Grinding may be employed to produce composites having any type of open frameworks encapsulating sulfur, silicon or tin. For example, in certain embodiments, grinding is used to produce composites with ZIFs (e.g., ZIF-8) encapsulating sulfur, silicon or tin.

Stirring

Any suitable methods and techniques known in the art may be used to stir the (i) organic linking compounds, (ii) metal compounds (present for producing MOF composites; absent for producing COF composites), and (iii) sulfur, silicon or tin. Stirring may be performed in a liquid medium, as discussed in further detail below. Stirring may be performed using any suitable apparatus known in the art. For example, stirring may be carried out using a stir bar or a mechanical stirrer (e.g., paddle, stir motor).

In the mechanochemical methods, the stirring of (i) organic linking compounds, (ii) metal compounds (present for producing MOF composites; absent for producing COF composites), and (iii) sulfur, silicon or tin may produce intrinsic heat, which may help with the formation of the composite. In certain embodiments, the composite is produced at a temperature below 30° C. or at about room temperature. In some embodiments of the method, stirring is performed without external heating.

The amount of time used for the stirring also may impact the formation of the composites, including, for example, the distribution of the sulfur, silicon or tin encapsulated in the open framework formed from the organic linking compounds and the metal compounds. In some embodiments of the method, the stirring is performed for at least 1 minute, at least 5 minutes, at least 10 minutes, at least 20 minutes, at least 30 minutes, at least 60 minutes, at least 120 minutes, at least 240 minutes, or at least 480 minutes; or between 5 minutes and 1000 minutes, between 5 minutes and 720 minutes, or between 5 minutes and 120 minutes.

The stirring may be performed under inert atmosphere. For example, the stirring of the mixture may be performed in the presence of an inert gas, such as argon or nitrogen. The stirring under inert atmosphere may help reduce the impurities produced.

Stirring may be employed to produce composites having any type of open framework encapsulating sulfur, silicon or tin. For example, in certain embodiments, stirring is used to produce composites with MOFs (e.g., MOF-5) encapsulating sulfur, silicon or tin.

Organic Linking Compounds

As used herein, “linking compound” refers to a monodentate or a bidendate compound that can bind to a metal or a plurality of metals. Various organic linking compounds may be used in the methods described herein. The organic linking compounds may be obtained from any commercially available sources, or prepared using any methods or techniques generally known in the art.

Organic linking compounds known in the art suitable for forming open frameworks may also be used. It should be understood that the types of organic linking compounds selected for use in the methods will determine the type of organic framework formed in the composite.

In some embodiments of the method where the organic framework of the composite produced is ZIF, the organic linking compound used in the method may be a monocyclic five-membered heteroaryl having at least two nitrogen atoms, wherein two of the nitrogen atoms are configured in the 1- and 3-positions of the monocyclic five-membered ring. It should be understood that such monocyclic five-membered ring (which may be optionally substituted) having nitrogen atoms at the 1- and 3-positions of the ring include:

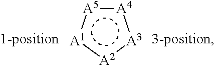

wherein A¹ and A³ are independently N or NH; and A², A⁴ and A⁵ are independently C, CH, N or NH (to the extent that such ring system is chemically feasible). In other embodiments of the method where the organic framework of the composite produced is ZIF, the organic linking compound used in the method may also be a bicyclic ring system made up of at least one five-membered ring having at least two nitrogen atoms, wherein two of the nitrogen atoms are configured in the 1- and 3-positions of the five-membered ring. The bicyclic ring system may further include a second five-membered ring or a six-membered ring fused to the first five-membered ring. It should be understood that such bicyclic ring system (which may be optionally substituted) made up of at least one five-membered ring having nitrogen atoms are configured in the 1- and 3-positions of the five-membered ring may include, for example:

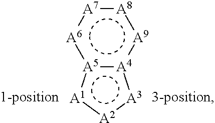

wherein A¹ and A³ are independently N or NH; and A², A⁴-A⁹ are independently C, CH, N or NH (to the extent that such ring system is chemically feasible).

In certain embodiments of the method for producing ZIF composites, the organic linking compound is unsubstituted or substituted imidazole, unsubstituted or substituted benzimidazole, unsubstituted or substituted triazole, unsubstituted or substituted benzotriazole, or unsubstituted or substituted purine (e.g., unsubstituted or substituted guanine, unsubstituted or substituted xanthine, or unsubstituted or substituted hypoxanthine).

Examples of organic linking compounds suitable for use in the mechanochemical methods for producing ZIF composites include:

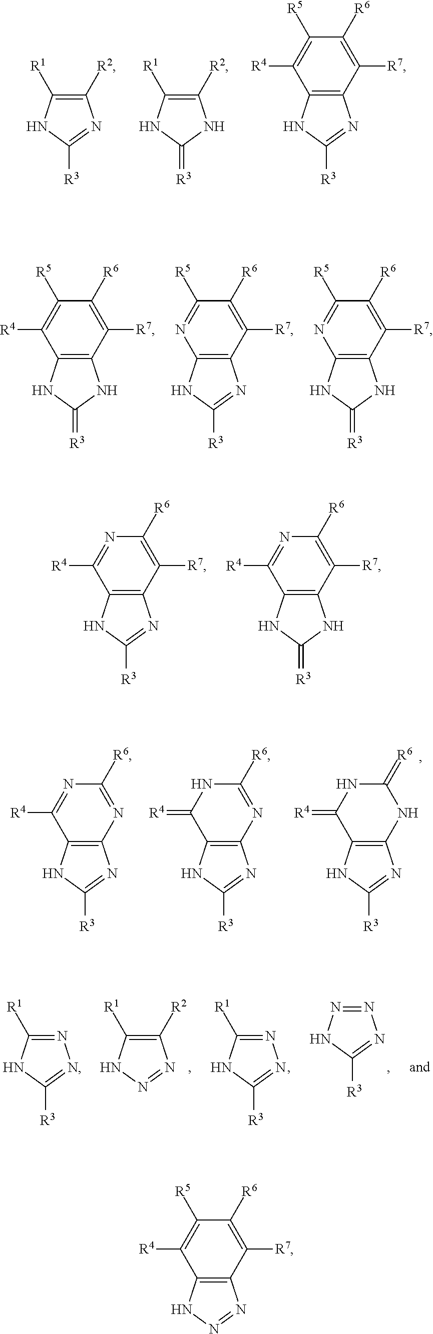

wherein:

each R¹, R², R³, R⁴, R⁵, R⁶ and R⁷ (when present) is independently selected from the group consisting of H, NH₂, COOH, CN, NO₂, F, Cl, Br, I, S, O, SH, SO₃H, PO₃H₂, OH, CHO, CS₂H, SO₃H, Si(OH)₃, Ge(OH)₃, Sn(OH)₃, Si(SH)₄, Ge(SH)₄, Sn(SH)₄, PO₃H, AsO₃H, AsO₄H, P(SH)₃, As(SH)₃, CH(R^{a}SH)₂, C(R^{a}SH)₃, CH(R^{a}NH₂)₂, C(R^{a}NH₂)₃, CH(R^{a}OH)₂, C(R^{a}OH)₃, CH(R^{a}CN)₂, C(R^{a}CN)₃,

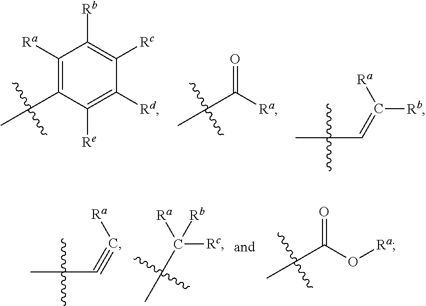

and

each R^{a}, R^{b}, and R^{c} (when present) is independently selected from the group consisting of H, alkyl (e.g. C₁₋₂₀ alkyl, or C₁₋₁₀ alkyl, or C₁₋₄ alkyl), NH₂, COOH, CN, NO₂, F, Cl, Br, I, S, O, SH, SO₃H, PO₃H₂, OH, CHO, CS₂H, SO₃H, Si(OH)₃, Ge(OH)₃, Sn(OH)₃, Si(SH)₄, Ge(SH)₄, Sn(SH)₄, PO₃H, AsO₃H, AsO₄H, P(SH)₃, and As(SH)₃.

In certain embodiments, each R¹, R², R³, R⁴, R⁵, R⁶ and R⁷ (when present) is independently H or

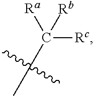

wherein each R^{a}, R^{b}, and R^{c} is H or alkyl (e.g. C₁₋₂₀ alkyl, or C₁₋₁₀ alkyl, or C₁₋₄ alkyl).

In other embodiments, the organic linking compound may have a structure of formula:

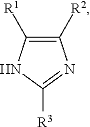

wherein:

each R¹ and R² is independently hydrogen, aryl (e.g., C₅₋₂₀ aryl, or C₅₋₆ aryl), alkyl (e.g. C₁₋₂₀ alkyl, or C₁₋₁₀ alkyl, or C₁₋₄ alkyl), halo (e.g., Cl, F, Br, or I), cyano, or nitro; or R¹ and R² are taken together with the carbon atoms to which they are attached to form a five- or six-membered heterocycle comprising 1, 2, or 3 nitrogen atoms; and

R³ is hydrogen or alkyl.

In certain embodiments, each R¹ and R² is hydrogen. In certain embodiments, each R¹ and R² is independently alkyl (e.g. C₁₋₂₀ alkyl, or C₁₋₁₀ alkyl, or C₁₋₄ alkyl). In certain embodiments, R³ is hydrogen. In certain embodiments, R³ is alkyl (e.g. C₁₋₂₀ alkyl, or C₁₋₁₀ alkyl, or C₁₋₄ alkyl). In one embodiment, R³ is methyl. In certain embodiments, each R¹ and R² is independently alkyl; and R³ is hydrogen. In one embodiment, each R¹ and R² is methyl; and R³ is hydrogen. In certain embodiments, each R¹ and R² is hydrogen; and R³ is alkyl. In one embodiment, each R¹ and R² is hydrogen; and R³ is methyl. In yet another embodiment of the composite, each R¹, R² and R³ is hydrogen.

In certain embodiments, the organic linking compound may have a structure selected from:

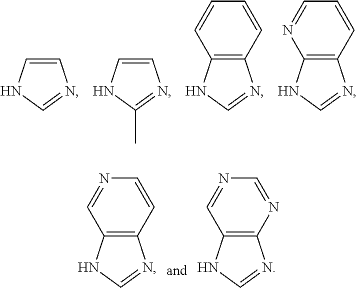

In certain embodiments, the organic linking compound may be an unsubstituted or substituted imidazole. Examples of such organic linking compounds include 2-alkyl imidazole (e.g., 2-methyl imidazole). In certain embodiments, the organic linking compound may an imidazole or imidazole derivative, including for example heterocyclic rings such as unsubstituted imidazole, unsubstituted benzimidazole, or imidazole or benzimidazole substituted with alkyl (e.g. C₁₋₂₀ alkyl, or C₁₋₁₀ alkyl, or C₁₋₄ alkyl), nitro, cyano, or halo (e.g., Cl, F, Br, or I) groups, wherein one or more carbon atoms on the imidazole or benzimidazole may be replaced with a nitrogen atom (to the extent chemically feasible).

In other embodiments of the method where the organic framework of the composite produced is MOF, the organic linking compound used in the method may be an aryl substituted with at least one carboxyl moiety, or a heteroaryl substituted with at least one carboxyl moiety. In certain embodiments, the organic linking compound used in the method may be an aryl with at least one phenyl ring substituted with a —COOH moiety, or a heteroaryl with at least pyridyl ring substituted with a —COOH moiety. In certain embodiments, the organic linking compound is an aryl with 1 to 5 phenyl rings, wherein at least one phenyl ring is substituted with a —COOH moiety, or a heteroaryl with 1 to 5 pyridyl rings, wherein at least pyridyl ring is substituted with a —COOH moiety.

When aryl includes two or more phenyl rings, the phenyl rings may be fused or unfused. When heteroaryl includes two or more pyridyl rings, or at least one pyridyl ring and at least one phenyl ring, such rings may be fused or unfused. It should be understood that an does not encompass or overlap in any way with heteroaryl. For example, if a phenyl ring is fused with or connected to a pyridyl ring, the resulting ring system is considered heteroaryl.

Examples of organic linking compounds suitable for use in the mechanochemical methods for producing MOF composites include:

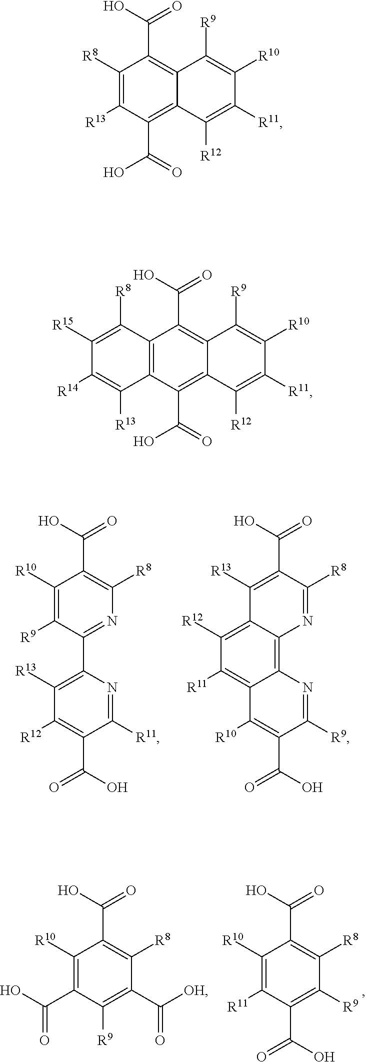

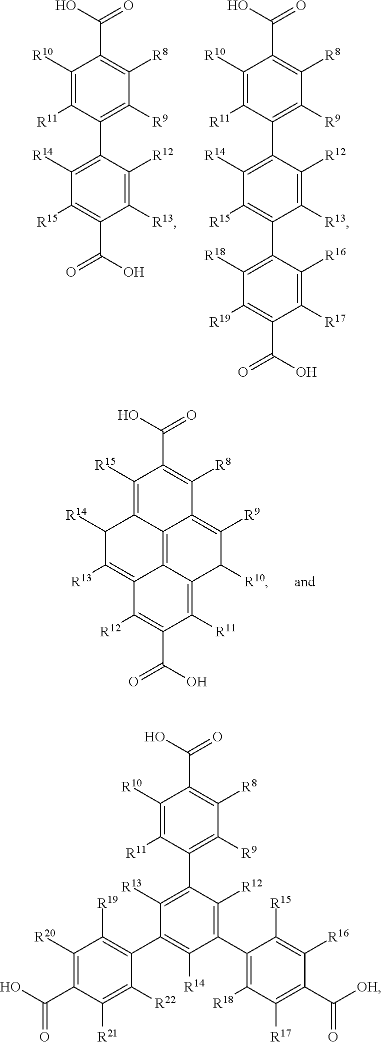

wherein:

each R⁸, R⁹, R¹⁰, R¹¹, R¹², R¹³, R¹⁴, R¹⁵, R¹⁶, R¹⁷, R¹⁸, R¹⁹, R²⁰, R²¹, and R²² (when present) is independently selected from the group consisting of H, NH₂, CN, OH, ═O, ═S, Br, Cl, I, F,

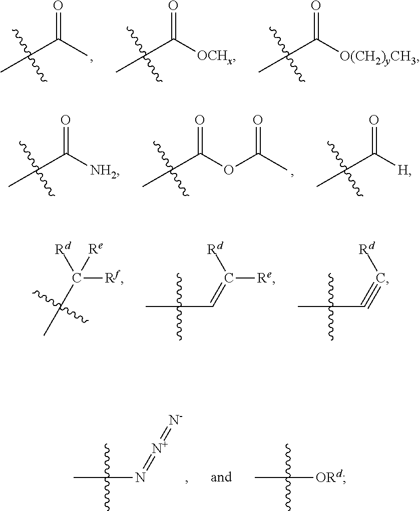

x and y (when present) is independently 1, 2 or 3; and

each R^{d}, R^{e} and R^{f} (when present) is independently H, alkyl (e.g. C₁₋₂₀ alkyl, or C₁₋₁₀ alkyl, or C₁₋₄ alkyl), NH₂, COOH, CN, NO₂, F, Cl, Br, I, S, O, SH, SO₃H, PO₃H₂, OH, CHO, CS₂H, SO₃H, Si(OH)₃, Ge(OH)₃, Sn(OH)₃, Si(SH)₄, Ge(SH)₄, or Sn(SH)₄.

In certain embodiments, each R⁸, R⁹, R¹⁰, R¹¹, R¹², R¹³, R¹⁴, R¹⁵, R¹⁶, R¹⁷, R¹⁸, R¹⁹, R²⁰, R²¹, and R²² (when present) is H.

In certain embodiments of the method for producing MOF composites, the organic linking compound may be an unsubstituted or substituted phenyl compound. The phenyl may, in one embodiment, be substituted with one or more carboxyl substituents. Examples of such organic linking compounds include trimesic acid, terephthalic acid, and 2-amino benzyl dicarboxylic acid.

In yet other embodiments of the method where the organic framework of the composite produced is COF, the organic linking compound used in the method may be an aromatic ring system with at least one phenyl ring optionally substituted with alkyl. In certain embodiments, the aromatic ring system may include one or more heteroatoms. Such heteroatoms may include, for example, nitrogen. In other embodiments, the aromatic ring system may coordinate to or chelate with a tetrahedral atom, or form a tetrahedral group or cluster.

Examples of organic linking compounds suitable for use in the mechanochemical methods for producing COF composites include:

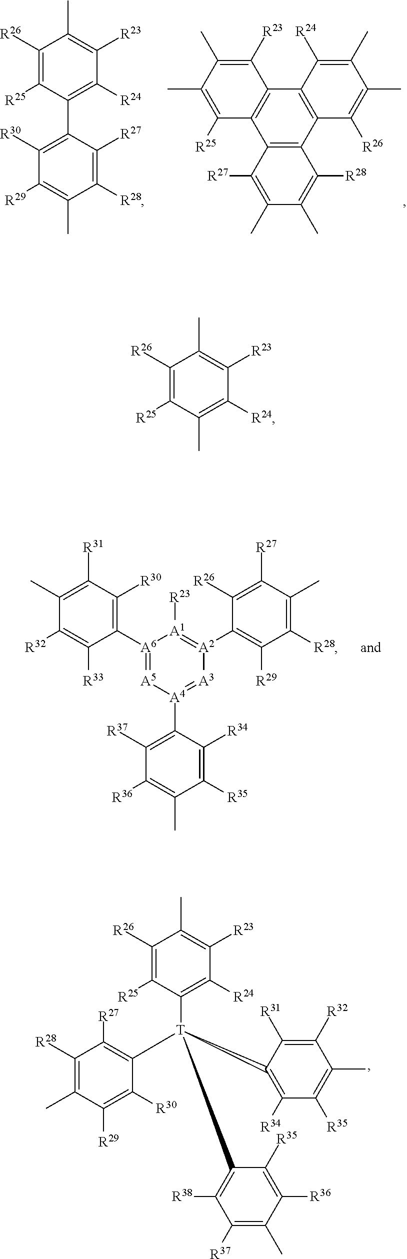

wherein:

each R²³, R²⁴, R²⁵, R²⁶, R²⁷, R²⁸, R²⁹, R³⁰, R³¹, R³², R³³, R³⁴, R⁵, R³⁶, and R³⁷ (when present) is independently selected from the group consisting of H, alkyl (e.g. C₁₋₂₀ alkyl, or C₁₋₁₀ alkyl, or C₁₋₄ alkyl), aryl (e.g., C₅₋₂₀ aryl, or C₅₋₆ aryl), OH, alkoxy (e.g. C₁₋₂₀alkoxy, or C₁₋₁₀ alkoxy, or C₁₋₄ alkoxy), alkenyl (e.g. C₂₋₂₀ alkenyl, or C₂₋₁₀ alkenyl, or C₂₋₄ alkenyl), alkynyl (e.g. C₂₋₂₀ alkynyl, or C₂₋₁₀ alkynyl, or C₂₋₄ alkynyl), sulfur-containing group (e.g., thioalkoxy), silicon-containing group, nitrogen-containing group (e.g., amides), oxygen-containing group (e.g., ketones and aldehydes), halo (e.g., Cl, F, Br, or I), nitro, amino, cyano, boron-containing group, phosphorus-containing group, carboxylic acid, and ester;

each A¹, A², A³, A⁴, A⁵ and A⁶ (when present) is independently absent or any atom or group capable of forming a stable ring structure; and

T (when present) is a tetrahedral atom or a tetrahedral group or cluster.

In certain embodiments, each R²³, R²⁴, R²⁵, R²⁶, R²⁷, R²⁸, R²⁹, R³⁰, R³¹, R³², R³³, R³⁴, R³⁵, R³⁶, and R³⁷ (when present) is independently H or alkyl (e.g. C₁₋₂₀ alkyl, or C₁₋₁₀ alkyl, or C₁₋₄ alkyl). In certain embodiments, T is a carbon atom, a silicon atom, a germanium atom, or a tin atom. In certain embodiments, T is a carbon group or cluster, a silicon group or cluster, a germanium group or cluster, or a tin group or cluster.

Metal Compounds

Metal ions can be introduced into the open framework via coordination or complexation with the functionalized organic linking moieties (e.g., imine or N-heterocyclic carbene) in the framework backbones or by ion exchange. The metal ions may be from metal compounds, including metal salts and complexes. Various metal compounds, including metal salts and complexes, may be used in the methods described herein. The metal compounds, including metal salts and complexes, may be obtained from any commercially available sources, or prepared using any methods or techniques generally known in the art. When metal is used in the methods described herein, the resulting open framework is a metal organic framework (MOF).

The metal compound may, for example, be selected from a zinc compound, a copper compound, an aluminum compound, a copper compound, an iron compound, a manganese compound, a titanium compound, a zirconium compound, or other metal compounds having one or more early transition metals (including, for example, Sc, Ti, V, Cr, Mn, Fe, Co, Ni, Cu, and Zn). In one embodiment, the metal compound is zinc oxide (ZnO), copper acetate (Cu(Ac)₂), aluminium acetate (Al(Ac)₃), zinc acetate (Zn(OAc)₂) or any combination thereof. It should be understood that salts and complexes of such metal compounds may also be used. For example, a dihydrate of zinc acetate, Zn(OAc)₂.2H₂O, may be used as the metal compound in the methods described herein.

The metal compound is made up of one or more metal ions. The metal ions may be transition metal ions. The metal ion(s) of the metal compound may be one that prefers tetrahedral coordination. One such example is Zn²⁺. Thus, in one variation, the metal compound has a Zn²⁺. Other suitable metal ions of the metal compound include, for example, Mg²⁺, Ca²⁺, Sr²⁺, Ba²⁺, Sc³⁺, Y³⁺, Ti⁴⁺, Zr⁴⁺, Hf⁴⁺, V⁴⁺, V³⁺, V²⁺, Nb³⁺, Ta³⁺, Cr³⁺, Mo³⁺, W³⁺, Mn³⁺, Mn²⁺, Re³⁺, Re²⁺, Fe³⁺, Fe²⁺, Ru³⁺, Ru²⁺, Os³⁺, Os²⁺, Co³⁺, Co²⁺, Rh²⁺, Rh⁺, Ir²⁺, Ir⁺, Ni²⁺, Ni⁺, Pd²⁺, Pd⁺, Pt²⁺, Pt⁺, Cu²⁺, Cu⁺, Ag⁺, Au⁺, Zn²⁺, Cd²⁺, Hg²⁺, Al³⁺, Ga³⁺, In³⁺, Tl³⁺, Si⁴⁺, Si²⁺, Ge⁴⁺, Ge²⁺, Sn⁴⁺, Sn²⁺, Pb⁴⁺, Pb²⁺, As⁵⁺, As³⁺, As⁺, Sb⁵⁺, Sb³⁺, Sb⁺, Bi⁵⁺, Bi³⁺, Bi⁺, or any combinations thereof. In some embodiments, the metal compound has one or more metal ions selected from Zn²⁺, Cu²⁺, Cu⁺, Al³⁺, Cu²⁺, Cu⁺, Fe³⁺, Fe²⁺, Mn³⁺, Mn²⁺, Ti⁴⁺, and Zr⁴⁺. In one embodiment, the metal compound has one or more metal ions selected from Zn²⁺, Cu²⁺, Cu⁺, Al³⁺, Cu²⁺, and Cu⁺.

The metal compound may, in certain instances, have one or more counterions. Suitable counterions may include, for example, acetate, nitrates, chloride, bromides, iodides, fluorides, and sulfates.

The metal ions described above can be introduced into the open frameworks via complexation with the organic linking moieties in framework backbones or by ion exchange.

Sulfur, Silicon and Tin

In one variation, the method involves mechanochemically processing (i) one or more organic linking compounds, (ii) one or more metal compounds (present for producing MOF composites; absent for producing COF composites), and (iii) sulfur. In another variation, the method involves mechanochemically processing (i) one or more organic linking compounds, (ii) one or more metal compounds (present for producing MOF composites; absent for producing COF composites), and (iii) silicon. In yet another, the method involves mechanochemically processing (i) one or more organic linking compounds, (ii) one or more metal compounds (present for producing MOF composites; absent for producing COF composites), and (iii) tin. The sulfur, silicon or tin used may, for example, be in elemental form (e.g., elemental sulfur, elemental silicon, or elemental tin).

Ratio of Starting Materials

The ratio of the (i) organic linking compounds, (ii) metal compounds (present for producing MOF composites; absent for producing COF composites), and (iii) sulfur, silicon or tin used may affect the structure of composite produced, and the amount of sulfur, silicon or tin encapsulated in the open frameworks produced. In some embodiments of the methods to produce MOF composites, the molar ratio of the (i) organic linking compounds, (ii) metal compounds, and (iii) sulfur, silicon or tin used is at least 1:0.2:0.1; or between 1:0.2:0.1 and 1:2:2. In certain embodiments of the methods to produce MOF composites, the amount of metal compounds, and the amount of sulfur, silicon or tin used has a molar ratio of at least 2:1 or between 2:1 and 1:1.

Liquid Medium

The methods described herein may be carried out in a liquid medium, e.g., in an aqueous or non-aqueous system. The use of a liquid medium can help the organic linking compounds, the metal compounds, and sulfur, silicon or tin come into better contact with each other when undergoing the mechanochemical processing. For example, in one embodiment, the method may involve grinding the (i) organic linking compounds, (ii) metal compounds (present for producing MOF composites; absent for producing COF composites), and (iii) sulfur, silicon or tin in a liquid medium. In another embodiment, the method may involve stirring the (i) organic linking compounds, (ii) metal compounds (present for producing MOF composites; absent for producing COF composites), and (iii) sulfur, silicon or tin in a liquid medium.

The liquid medium may include one solvent or a mixture of solvents. Certain solvents used may dissolve at least a portion of the starting materials used in the mechanochemical methods described herein. The liquid medium may be polar or nonpolar. The liquid medium may include, for example, n-alkanes, n-alcohols, aromatic solvents, chlorinated solvents, ether solvents, or ketone solvents, or any mixtures thereof. In certain embodiments, liquid medium may include, for example, water, pentane, hexane, methanol, ethanol, n-propanol, isopropanol, benzene, toluene, xylene, chlorobenzene, nitrobenzene, cyanobenzene, aniline, naphthalene, naphthas, acetone, 1,2,-dichloroethane, methylene chloride, chloroform, carbon tetrachloride, tetrahydrofuran, dimethylformamide, dimethylsulfoxide, N-methylpyrollidone, dioxane, dimethylacetamide, diethylformamide, thiophene, pyridine, ethanolamine, triethylamine, or ethylenediamine, or any mixtures thereof.

In some embodiments of the method, the liquid medium is less than 15 wt %, less than 10 wt %, or less than 5 wt % of the materials undergoing mechanochemical processing.

Additional Steps

The methods described herein to produce the composites may include one or more additional steps. For example, in some embodiments, the method further includes heating the composite produced after the mechanochemical processing step. The composite may be heated to a temperature suitable to enhance the diffusion of the sulfur, silicon and tin. The composite may be further burned or calcined under inert gas or air to obtain composites with sulfur, silicon or tin encapsulated in the resulting porous carbon/metal oxides. In certain embodiments, the composite is heated to a temperature between 100° C. and 1200° C., between 100° C. and 200° C., or between 300° C. and 1200° C. In one variation, the composite is subjected to a melt diffusion process after grinding.

The methods described herein may also include further functionalizing the composites produced. The organic linking compounds incorporated into the composite have one or more reactive functional groups that can be chemically transformed by a suitable reactant to further functionalize the linking moieties for complexation of the metal ion(s). Thus, in one variation, the method further includes functionalizing the composite produced from the grinding step. In another variation, the method further includes: heating the composite produced from the grinding step; and further functionalizing the composite produced from the heating step.

Reactants suitable for use to further functionalize the composite may include any reactants suitable for coordinating with or chelating the one or more metal ions in the open frameworks of the composite. The reactants may be used to generate a chelating group for the addition of a metal. Suitable reactants may include, for example, unsubstituted or substituted heterocycloalkyls, R′C(═O)R″, or R′C(═O)OC(═O)R″, wherein R′ and R″ are each independently H, alkyl, aryl, OH, alkoxy, alkenes, alkynes, sulfur-containing groups (e.g., thioalkoxy), silicon-containing groups, nitrogen-containing groups (e.g., amides), oxygen-containing groups (e.g., ketones and aldehydes), halogen (e.g., chloro, fluoro, bromo, iodo), nitro, amino, cyano, boron-containing groups, phosphorus-containing groups, carboxylic acids, or esters. For example, in one variation of the method where the composite is further functionalized, the reactant may be a heterocycle having 1 to 20 ring carbon atoms, with 1 to 3 ring heteroatoms independently selected from nitrogen, oxygen and sulfur.

It should be understood that a “heterocycle” is a ring-containing structure of molecule having one or more ring heteroatoms independently selected from nitrogen, oxygen and sulfur. The heterocycle may be saturated or unsaturated, and the heterocycle may contain more than one ring. When the heterocycle contains more than one ring, the rings may be fused or unfused. Fused rings generally refer to at least two rings sharing two atoms therebetween.

Suitable reactants include, for example,

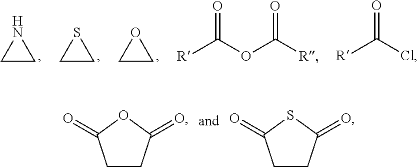

where R′ and R″ as are defined above.

Suitable methods to further functionalize the composites produced by the mechanochemical methods described herein are described, for example, in US 2012/0130113 (which is hereby incorporated herein by reference specifically with respect to paragraphs [0048]-[0053]).

The methods described herein may also include further calcining or carbonizing the composites. For example, in certain embodiments, the silicon or tin composites are further calcined or carbonized. The composites may be calcined or carbonized by heating the composite to a suitable temperature. In certain embodiments of the methods, the composites are further heated to a temperature between 300° C. to 1100° C., or between 500° C. and 800° C. to calcine or carbonize the composite. Any suitable methods or techniques known in the art may be employed to calcine or carbonize the composites.

When the MOF composites are calcined or carbonized, the metal ions may partially dissociate from the organic linking groups of the MOF and yield metal ions embedded in a conductive porous carbon matrix that is derived from the organic linking groups of the MOF.

For example, the calcining or carbonization of a MOF composite can be illustrated with respect to a MIL-53 composite. It is generally known in the art that MIL-53 includes at least one of the following moiety:

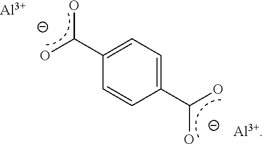

Without wishing to be bound by any theory, when MIL-53 is calcined or carbonized, the aluminum ions may partially dissociate from the carboxylic groups and yield Al₂O₃ (alumina) embedded in a conductive porous carbon matrix that is derived from the 1,4-benzenedicarboxylic acid linkers of MIL-53. Further, the alumina may be produced at a sub-nano scale according to the methods described herein; and the alumina (in the form of Al³⁺) may evenly be distributed in nano scale within the carbon matrix formed. When the methods described herein are employed, conglomeration is not typically observed, whereas severe clustering is typically observed when alumina is coated onto the lithium metal oxide using techniques and methods presently known in the art.

In some variations, the carbon matrix produced from calcining or carbonizing MIL-53 may be depicted as having at least one moiety as follows:

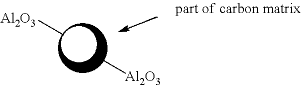

More generally, in other variations, the carbon matrix produced from calcining or carbonizing metal-organic frameworks may be depicted as having at least one moiety as follows:

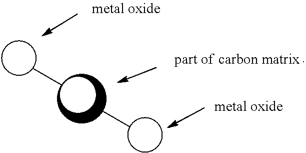

In certain embodiments of the calcined or carbonized MOF composite described herein or provided according to the methods described herein, the metal oxide particles are uniformly dispersed within the porous carbon matrix. In some variations, “uniformly dispersed” refers to metal oxide particles spaced in a repeating pattern within a carbon matrix. In one variation, such metal oxide particles may be uniformly dispersed in a carbon matrix when a metal-organic framework shell is pyrolyzed.

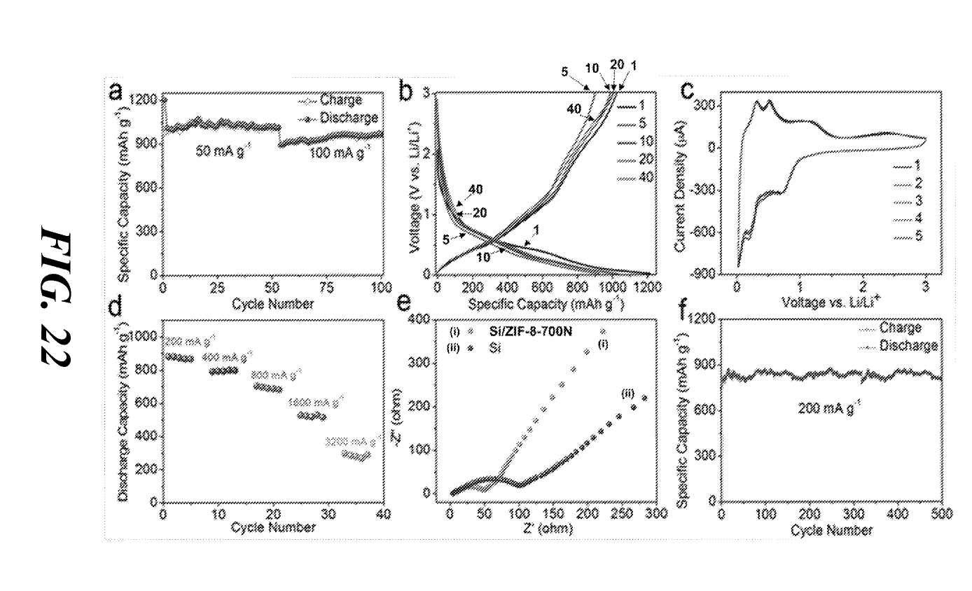

In other embodiments of the calcined or carbonized MOF composite described herein or provided according to the methods described herein, the metal oxide particles are dispersed to form a porous layer or film that covers sulfur, silicon or tin. In one embodiment, the metal oxide particles are dispersed to form a porous layer or film that completely cover the sulfur, silicon or tin. For example, FIG. 21(d) provides elemental maps of carbonized Si/ZIF-8 that indicate zinc was dispersed to completely covered the silicon.

### Structure, Characterization and Other Properties of the Composites

In the case of MOF composites, the methods provided herein yield composites made up of open frameworks in which the metal ion(s) of the metal compound(s) coordinate with or chelate the organic linking compound(s) to form one-, two- or three-dimensional structures that are porous. In the case of COF composites, the methods provided herein yield composites made up of open frameworks with organic linking compounds that coordinate to form one-, two- or three-dimensional structures that are porous. Thus, provided herein are also composites made up of porous open frameworks, wherein sulfur, silicon or tin occupies at least a portion of the pores of the open frameworks.

The composites provided herein or produced according to the methods described herein may be characterized using any suitable methods and techniques known in the art. For example, the composite may be characterized by X-ray powder diffraction (XRPD), scanning electron microscope (SEM), nitrogen adsorption-desorption isotherms, and thermal gravimetric analysis (TGA).

Types of Open Frameworks

In some embodiments, the methods provided herein may yield composites that have metal-organic frameworks (MOFs). The MOFs of the composites have structures that are based on repeating cores of bidentate or polydentate organic ligands coordinating with metal ions. In certain embodiments of the composites provided herein, MOF cores have M-L-M connectivity, where M is any suitable metal ion described herein, and L is any suitable organic ligand described herein. The repeating cores form a porous framework, in which the sulfur, silicon or tin used in the mechanochemical methods described herein occupy at least a portion of the pores.

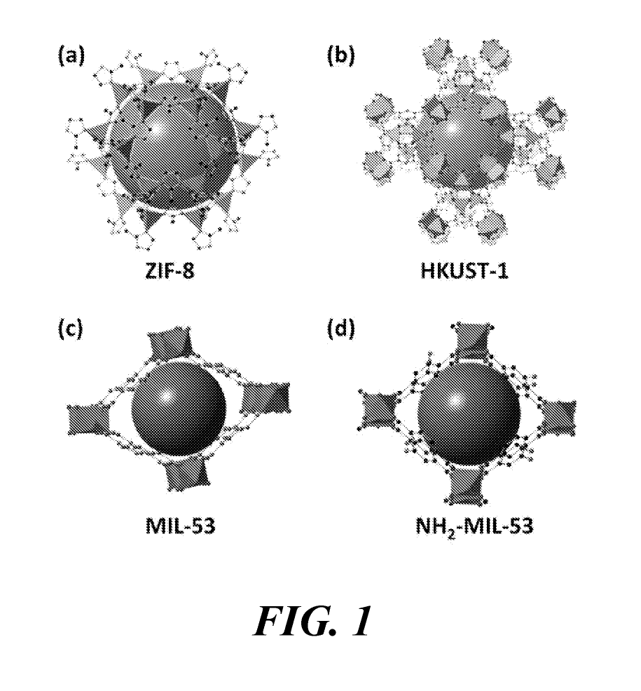

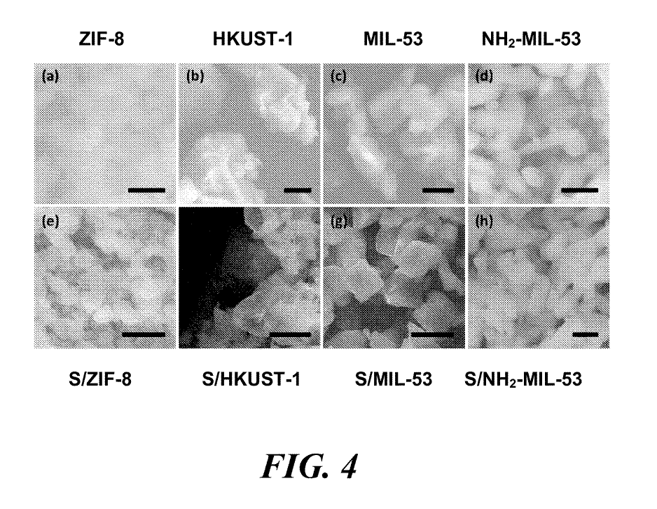

In some embodiments, the methods provided herein may yield composites that have zeolitic imidazolate frameworks (ZIFs). Such frameworks are made up of repeating cores with a zeolite-type structure. The ZIFs of the composite provided herein or produced according to the mechanochemical methods described herein are based on repeating cores of metal nodes tetrahedrally coordinated by imidazolate or imidazolate-derivative structures. Suitable ZIF structures are further described in, for example, US 2010/0186588 (which is hereby incorporated herein by reference specifically with respect to paragraphs [0005]-[0013], [0053], [0055]-[0069], and FIGS. 1A-1E, 3A, 3B, and 4E). The repeating cores form a porous framework, in which the sulfur, silicon or tin used in the mechanochemical methods described herein occupy at least a portion of the pores.

For example, when imidazole or imidazole-derivatives are used as the organic linking compounds in the mechanochemical methods described herein, the imidazole moiety (or derivative thereof) can lose a proton to form an imidazolate moiety (or derivative thereof). In certain embodiments of the composites provided herein, the core of the ZIF composite may have a formula of T-(Im)-T, where “Im” is imidazolate (or derivative thereof), and “T” is a tetrahedrally-bonded metal ion. Such repeating cores form a porous framework. In certain embodiments, imidazolate or imidazolate-derivative structures may include, for example, heterocyclic rings such as unsubstituted imidazolate, unsubstituted benzimidazolate, or imidazolate or benzimidazolate substituted with alkyl (e.g., methyl), nitro, cyano, or halo (e.g., chloro) groups, wherein one or more carbon atoms on the imidazolate or benzimidazolate may be replaced with a nitrogen atom (to the extent chemically feasible).

The structures of such ZIFs are known in the art. For example, it is recognized that ZIF-8 is made up of repeating core units of zinc ions coordinating with 2-methyl imidazole, and such repeating core units form a porous framework. Thus, in a ZIF-8 composite, the sulfur, silicon or tin occupies at least a portion of the pores of the ZIF-8.

In other embodiments, the methods provided herein may yield composites that include covalent organic frameworks (COFs). COF composites produced according to the methods described herein include, for example, COF-1, COF-5, TpPa-1 and TpPa-2. The structures of such COFs are known in the art.

The composites may be neutral or charged. In certain embodiments where the composite is charged, the composite may coordinate with one or more counterions. For example, counter cations may include H⁺, Na⁺, K⁺, Mg₂⁺, Ca₂⁺, Sr₂⁺, ammonium ion, alkyl-substituted ammonium ions, and aryl-substituted ammonium ions; and counter anions may include F, Cl⁻, Br, F, ClO⁻, ClO₂⁻, ClO₃⁻, ClO₄⁻, OH⁻, NO₃⁻, NO₂⁻, SO₄⁻, SO₃⁻, PO₃⁻, CO₃⁻, PF₆⁻ and organic counter ions such as acetate CH₃CO₂⁻, and triphlates CF₃SO₃⁻. Such counterions may be present from, for example, the metal compound used in the methods described herein.

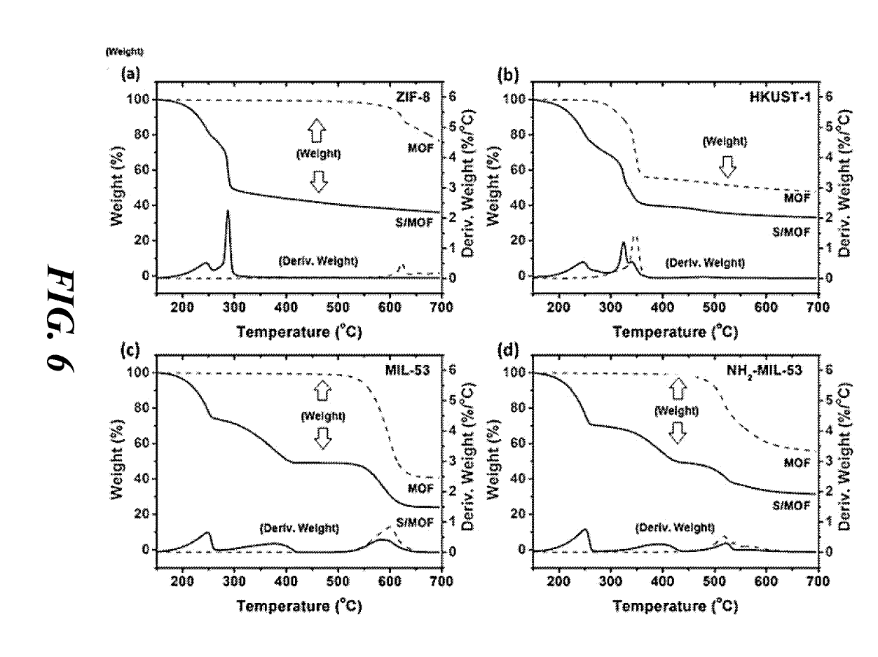

The mechanochemical methods described herein may be employed to produce open frameworks having structures as described in, for example, US2012/0259117 (which is hereby incorporated herein by reference specifically with respect to paragraphs [0006], [0051]-[0071], Schemes 1-3, and FIGS. 6A, 6B and 6C); US 2012/0130113 (which is hereby incorporated herein by reference specifically with respect to paragraphs [0008]-[0010], [0040]-[0047], and FIGS. 1A-D); and US 2013/0023402 (which is hereby incorporated herein by reference specifically with respect to paragraphs [0004]-[0007], [0073]-[0078], and FIGS. 1, 5-16, 37, 38, 40-43).

In some aspects, provided is a composite produced according to any of the mechanochemical methods described herein. In some embodiments, provided is a composite produced according to any mechanochemical methods involving grinding, as described herein. For example, provided is a S/ZIF composite, Si/ZIF composite, Sn/ZIF composite, S/MOF composite, Si/MOF composite, Sn/MOF composite, S/COF composite, Si/COF composite or Sn/COF composite produced according to any mechanochemical methods involving grinding, as described herein. In other embodiments, provided is a composite produced according to any mechanochemical methods involving stirring, as described herein. For example, provided is a S/ZIF composite, Si/ZIF composite, Sn/ZIF composite, S/MOF composite, Si/MOF composite, Sn/MOF composite, S/COF composite, Si/COF composite or Sn/COF composite produced according to any mechanochemical methods involving stirring, as described herein.

In other aspects, the composites provided herein or produced according to the mechanochemical methods described herein have an open framework with a repeating core of structure M-L-M, wherein M is a metal ion as described herein, and L is an organic linking moiety as described herein, and wherein the open framework has one or more pores, and sulfur, silicon or tin occupies at least a portion of the one or more pores.

In some embodiments of the composite, the M-L-M structure may be selected from

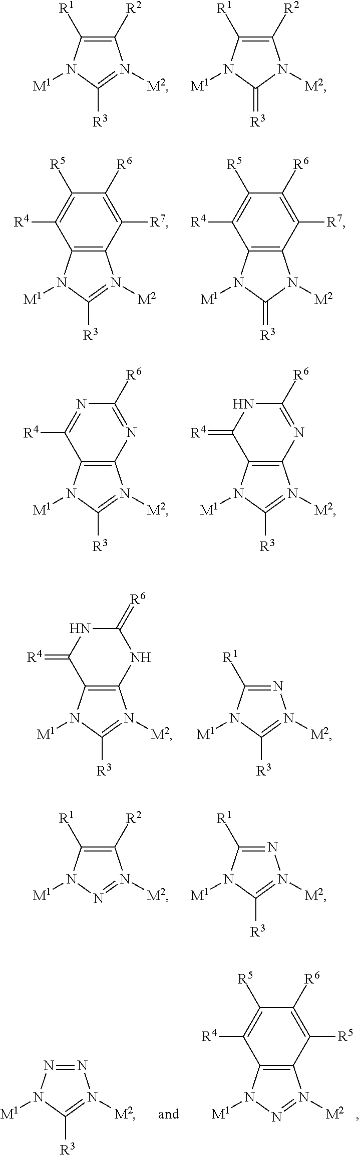

wherein:

each R¹, R², R³, R⁴, R⁵, R⁶ and R⁷ (when present) is independently selected from the group consisting of H, NH₂, COOH, CN, NO₂, F, Cl, Br, I, S, O, SH, SO₃H, PO₃H₂, OH, CHO, CS₂H, SO₃H, Si(OH)₃, Ge(OH)₃, Sn(OH)₃, Si(SH)₄, Ge(SH)₄, Sn(SH)₄, PO₃H, AsO₃H, AsO₄H, P(SH)₃, As(SH)₃, CH(R^{a}SH)₂, C(R^{a}SH)₃, CH(R^{a}NH₂)₂, C(R^{a}NH₂)₃, CH(R^{a}OH)₂, C(R^{a}OH)₃, CH(R^{a}CN)₂, C(R^{a}CN)₃,

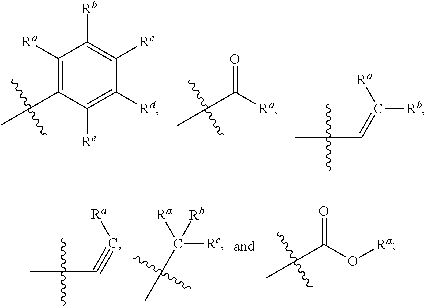

each R^{a}, R^{b}, and R^{c} (when present) is independently selected from the group consisting of H, alkyl (e.g. C₁₋₂₀ alkyl, or C₁₋₁₀ alkyl, or C₁₋₄ alkyl), NH₂, COOH, CN, NO₂, F, Cl, Br, I, S, O, SH, SO₃H, PO₃H₂, OH, CHO, CS₂H, SO₃H, Si(OH)₃, Ge(OH)₃, Sn(OH)₃, Si(SH)₄, Ge(SH)₄, Sn(SH)₄, PO₃H, AsO₃H, AsO₄H, P(SH)₃, and As(SH)₃; and

each M¹ and M² is independently selected from the group consisting of Zn²⁺, Mg²⁺, Ca²⁺, Sr²⁺, Ba²⁺, Sc³⁺, Y³⁺, Ti⁴⁺, Zr⁴⁺, Hf⁴⁺, V⁴⁺, V³⁺, V²⁺, Nb³⁺, Ta³⁺, Cr³⁺, Mo³⁺, W³⁺, Mn³⁺, Mn²⁺, Re³⁺, Re²⁺, Fe³⁺, Fe²⁺, Ru³⁺, Ru²⁺, Os³⁺, Os²⁺, Co³⁺, Co²⁺, Rh²⁺, Rh⁺, Ir²⁺, Ir⁺, Ni²⁺, Ni⁺, Pd²⁺, Pd⁺, Pt²⁺, Pt⁺, Cu²⁺, Cu⁺, Ag⁺, Au⁺, Zn²⁺, Cd²⁺, Hg²⁺, Al³⁺, Ga³⁺, In³⁺, Tl³⁺, Si²⁺, Ge⁴⁺, Ge²⁺, Sn⁴⁺, Sn²⁺, Pb⁴⁺, Pb²⁺, As⁵⁺, As³⁺, As⁺, Sb⁵⁺, Sb³⁺, Sb⁺, Bi⁵⁺, Bi³⁺, and Bi⁺.

In other embodiments, the composite has a M-L-M structure of:

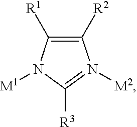

wherein:

each R¹ and R² is independently hydrogen, aryl (e.g., C₅₋₂₀ aryl, or C₅₋₆ aryl), alkyl (e.g. C₁₋₂₀ alkyl, or C₁₋₁₀ alkyl, or C₁₋₄ alkyl), halo (e.g., Cl, F, Br, or I), cyano, or nitro; or R¹ and R² are taken together with the carbon atoms to which they are attached to form a five- or six-membered heterocycle comprising 1, 2, or 3 nitrogen atoms;

R³ is hydrogen or alkyl; and

each M¹ and M² is independently Zn²⁺, Cu²⁺, Cu⁺, or Al³⁺.

In certain embodiments of the composite, each R¹ and R² is hydrogen. In certain embodiments of the composite, each R¹ and R² is independently alkyl (e.g. C₁₋₂₀ alkyl, or C₁₋₁₀ alkyl, or C₁₋₄ alkyl). In certain embodiments of the composite, R³ is hydrogen. In certain embodiments of the composite, R³ is alkyl (e.g. C₁₋₂₀ alkyl, or C₁₋₁₀ alkyl, or C₁₋₄ alkyl). In one embodiment of the composite, R³ is methyl. In certain embodiments of the composite, each R¹ and R² is independently alkyl; and R³ is hydrogen. In one embodiment, each R¹ and R² is methyl; and R³ is hydrogen. In certain embodiments of the composite, each R¹ and R² is hydrogen; and R³ is alkyl. In one embodiment, each R¹ and R² is hydrogen; and R³ is methyl. In yet another embodiment of the composite, each R¹, R² and R³ is hydrogen.

In certain embodiments of the composite, each M¹ and M² is Zn²⁺.

In certain embodiments, the composite has a M-L-M structure selected from

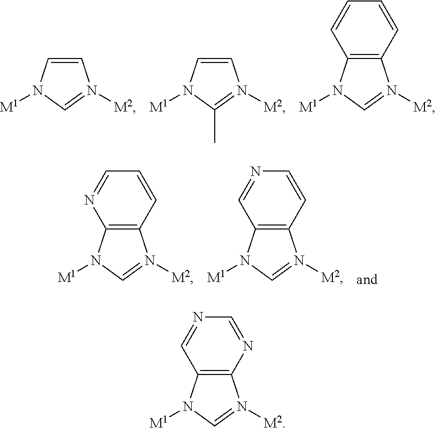

In other embodiments of the composite, the M-L-M has a structure wherein L is selected from:

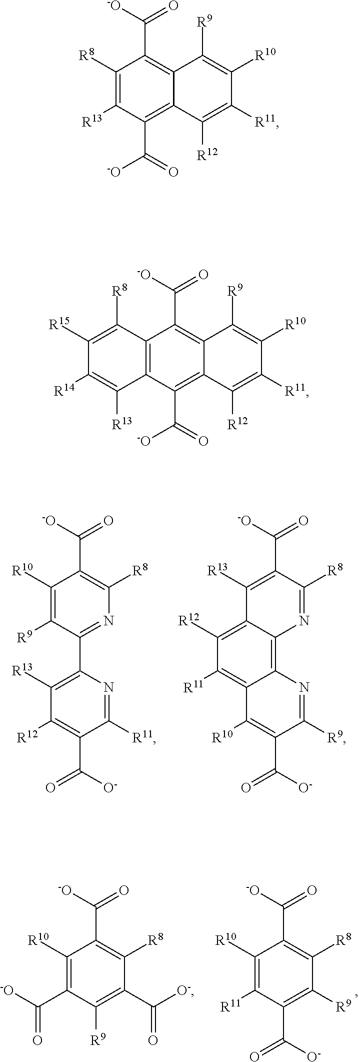

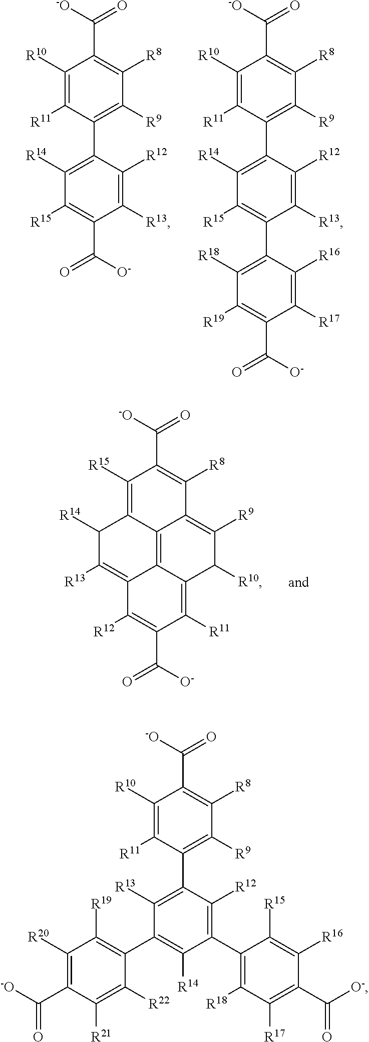

wherein:

each R⁸, R⁹, R¹⁰, R¹¹, R¹², R¹³, R¹⁴, R¹⁵, R¹⁶, R¹⁷, R¹⁸, R¹⁹, R²⁰, R²¹, and R²² (when present) is independently selected from the group consisting of H, NH₂, CN, OH, ═O, ═S, Br, Cl, I, F,

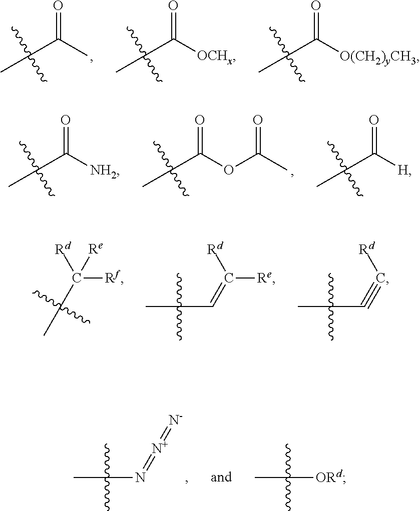

x and y (when present) is independently 1, 2 or 3; and

each R^{d}, R^{e} and R^{f} (when present) is independently H, alkyl (e.g. C₁₋₂₀ alkyl, or C₁₋₁₀ alkyl, or C₁₋₄ alkyl), NH₂, COOH, CN, NO₂, F, Cl, Br, I, S, O, SH, SO₃H, PO₃H₂, OH, CHO, CS₂H, SO₃H, Si(OH)₃, Ge(OH)₃, Sn(OH)₃, Si(SH)₄, Ge(SH)₄, or Sn(SH)₄; and

wherein each M is independently selected from the group consisting of Zn²⁺, Mg²⁺, Ca²⁺, Sr²⁺, Ba²⁺, Sc³⁺, Y³⁺, Ti⁴⁺, Zr⁴⁺, Hf⁴⁺, V⁴⁺, V³⁺, V²⁺, Nb³⁺, Ta³⁺, Cr³⁺, Mo³⁺, W³⁺, Mn³⁺, Mn²⁺, Re³⁺, Re²⁺, Fe³⁺, Fe²⁺, Ru³⁺, Ru²⁺, Os³⁺, Os²⁺, Co³⁺, Co²⁺, Rh²⁺, Rh⁺, Ir²⁺, Ir⁺, Ni²⁺, Ni⁺, Pd²⁺, Pd⁺, Pt²⁺, Pt⁺, Cu²⁺, Cu⁺, Ag⁺, Au⁺, Zn²⁺, Cd²⁺, Hg²⁺, Al³⁺, Ga³⁺, In³⁺, Tl³⁺, Si²⁺, Ge⁴⁺, Ge²⁺, Sn⁴⁺, Sn²⁺, Pb⁴⁺, Pb²⁺, As⁵⁺, As³⁺, As⁺, Sb⁵⁺, Sb³⁺, Sb⁺, Bi⁵⁺, Bi³⁺, and Bi⁺.

It should be understood that the carboxylate group(s) of the ligand (L) coordinates with the metal ion (M). In certain embodiments of the composite, each M is independently Zn²⁺, Cu²⁺, Cu⁺, or Al³⁺. In one embodiment, each M is Zn²⁺.

The open frameworks described above may have any suitable topologies known in the art. In certain embodiments of the composites described above, the open framework has a topology selected from the group consisting of ABW, AGO, AEI, AEL, AEN, AET, AFG, AFI, AFN, AFO, AFR, AFS, AFT, AFX, AFY, AHT, ANA, APC, APD, AST, ATN, ATO, ATS, ATT, ATV, AWO, AWW, BEA, BIK, BOG, BPH, BRE, CAN, CAS, CFI, CGF, CGS, CHA, CHI, CLO, CON, CZP, DAC, DDR, DFO, DFT, DOH, DON, EAB, EDI, EMT, EPI, ERI, ESV, EUO, FAU, FER, GIS, GME, GOO, HEU, IFR, ISV, ITE, JBW, KFI, LAU, LEV, LIO, LOS, LOV, LTA, LTL, LTN, MAZ, MEI, MEL, MEP, MER, MFI, MFS, MON, MOR, MSO, MTF, MTN, MTT, MTW, MWW, NAT, NES, NON, OFF, OSI, PAR, PAU, PHI, RHO, RON, RSN, RTE, RTH, RUT, SAO, SAT, SBE, SBS, SBT, SFF, SGT, SOD, STF, STI, STT, TER, THO, TON, TSC, VET, VFI, VNI, VSV, WIE, WEN, YUG and ZON, or any combinations thereof.

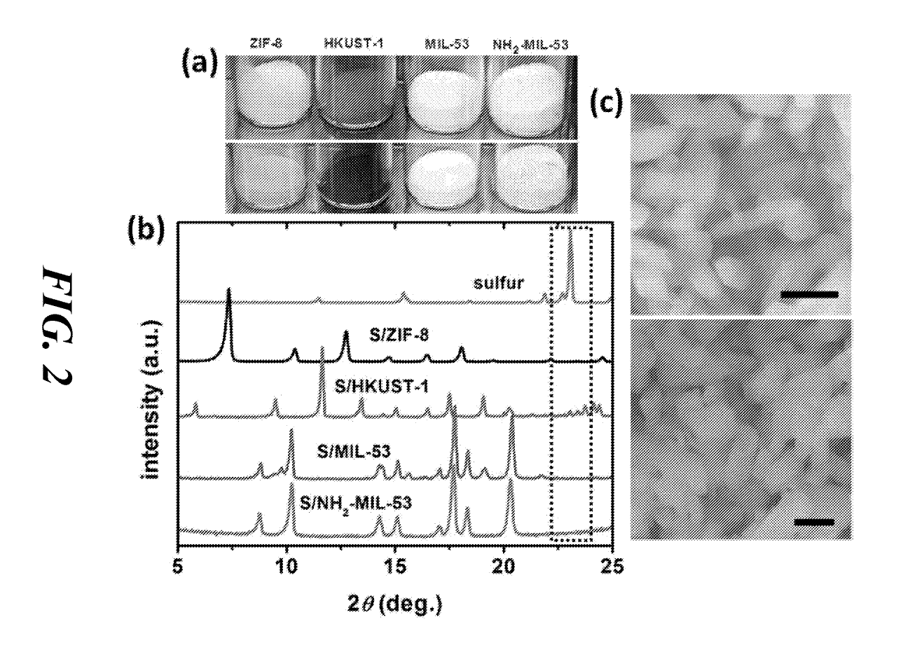

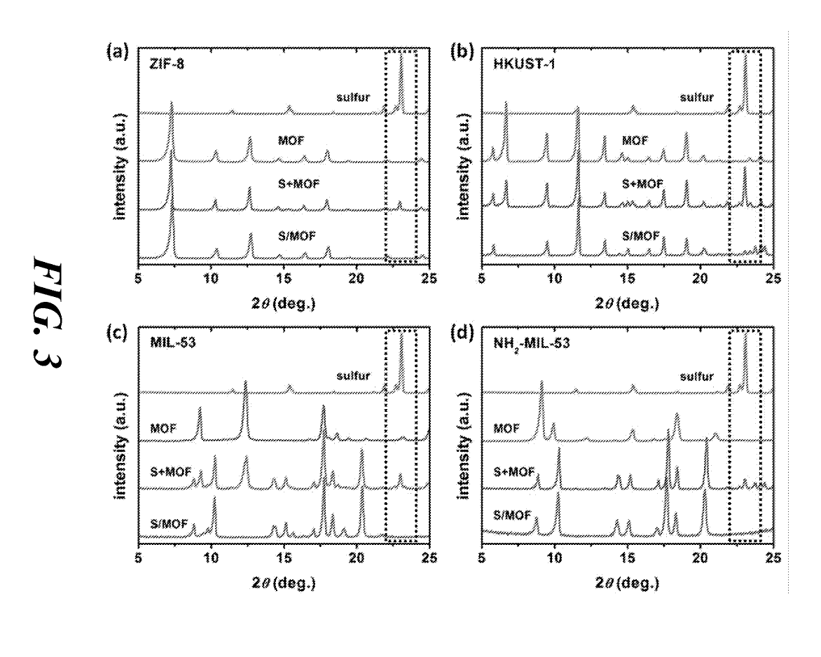

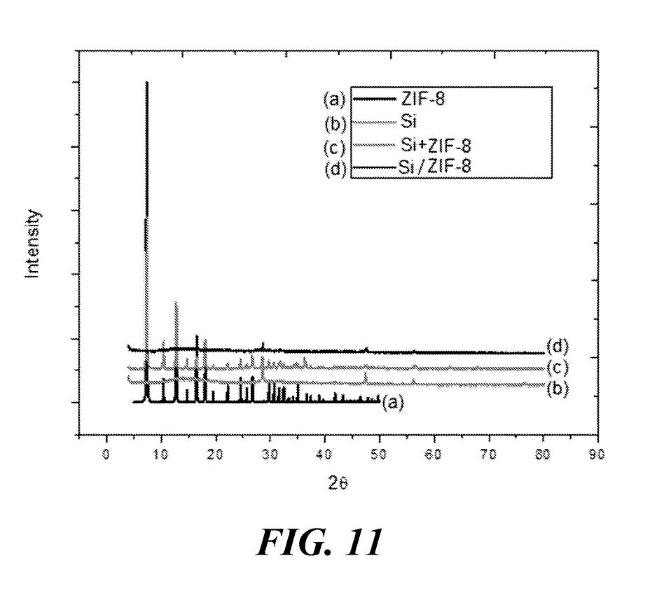

In one aspect, provided is a S/ZIF-8 composite having an XRPD pattern substantially as shown in FIG. 2B (referring to the pattern labeled “S/ZIF-8”) or FIG. 3(a) (referring to the pattern labeled “S/MOF”). In another aspect, provided is a S/HKUST-1 composite having an XRPD pattern substantially as shown in FIG. 2B (referring to the pattern labeled “S/HKUST-1”) or FIG. 3(b) (referring to the pattern labeled “S/MOF”). In another aspect, provided is a S/MIL-53 composite having an XRPD pattern substantially as shown in FIG. 2B (referring to the pattern labeled “S/MIL-53”) or FIG. 3(c) (referring to the pattern labeled “S/MOF”). In yet another aspect, provided is a S/NH₂-MIL-53 composite having an XRPD pattern substantially as shown in FIG. 2B (referring to the pattern labeled “NH₂-MIL-53”) or FIG. 3(d) (referring to the pattern labeled “S/MOF”). In another aspect, provided is a Si/ZIF-8 composite having an XRPD pattern substantially as shown in FIG. 11 (referring to the pattern labeled “Si/ZIF-8”). The term “substantially as shown in” when referring, for example, to an XRPD pattern, includes a pattern that is not necessarily identical to those depicted herein, but that falls within the limits of experimental error or deviations when considered by one of ordinary skill in the art.

Pores in the Composite

The composites provided herein or produced according to the methods described herein are porous. As used herein, “pores” refers to the cavities and/or channels of the composite. Pore size can be determined by any methods or techniques known in the art. For example, pore size can be calculated using density functional theory (DFT) or X-ray crystallography (e.g., single crystal data).

Certain open frameworks have one pore type, which the radii of the pores are substantially identical. Such open frameworks having one pore type include, for example, ZIF-8 and MIL-53. Other open frameworks may have two or more pore types. Such open frameworks having two or three different pore types include, for example, HKUST-1 and MOF-5.

In some embodiments, the composite has an average pore size of less than 10 Å, less than 9 Å, less than 8 Å, or less than 7 Å; or between 3 Å and 10 Å. In other embodiments, the composite has an average pore size between 2 nm and 100 nm.

The pores of the composite may be interconnected by apertures, which may be in the form of channels and/or windows. As used herein, “aperature diameter” refers to the largest diameter of the aperatures in the composite. Aperature diameter may be determined using any suitable methods or techniques known in the art. For example, the aperature diameter of the composite may be determined by measuring the aperature diameter of the corresponding open framework without the sulfur, silicon or tin encapsulated. The aperature diameter of an open framework (without the sulfur, silicon or tin encapsulated) may, for example, be determined by X-ray crystallography (e.g., single crystal data).

In some embodiments, the composites have an average aperature diameter of less than 10 Å, less than 9 Å, less than 8 Å, or less than 7 Å; or between 3 Å and 10 Å, or between 3 Å and 7 Å. In certain embodiments, the composites have: (i) an average pore size between 3 Å and 10 Å, or between 2 nm and 100 nm; (ii) an average aperature diameter between 3 Å and 7 Å.

It should be understood that each pore of the composite may host one or more sulfur, silicon or tin atoms, depending on the pore size and aperture diameter.

Loading and Distribution of Sulfur, Silicon or Tin

The sulfur, silicon or tin occupies at least a portion of the one or more pores of the composite provided herein or produced according to the methods described herein. In some embodiments of the composite, the sulfur, silicon or tin encapsulated in the open framework is evenly distributed in the one or more pores. Thus, provided is a composite made up of a metal-organic framework (MOF) or a covalent organic framework (COF) having one or more pores, wherein sulfur, silicon or tin is evenly distributed in at least a portion of the one or more pores.

The distribution of the sulfur, silicon or tin can be determined by comparing the XRPD pattern of the mixture of (i) the organic linking compound(s), (ii) the metal compound(s) (present for producing MOF composites; absent for producing COF composites), and (iii) the sulfur, silicon or tin before grinding, and the XRPD pattern of the composite produced after grinding. As used herein, “even distribution” occurs when the peak corresponding to sulfur, silicon or tin in the XRPD of the composite is absent or has an intensity of less than 100 (a.u.), less than 90 (a.u.), less than 80 (a.u.), less than 70 (a.u.), less than 60 (a.u.), less than 50 (a.u.), less than 40 (a.u.), less than 30 (a.u.), less than 20 (a.u.), or less than 10 (a.u.). Unless otherwise stated, the XRPD patterns provided herein are generated by a powder X-ray diffractometer at room temperature.

One of skill in the art would recognize the peak corresponding to sulfur, silicon or tin in an XRPD pattern. For example, under ambient conditions, the peak corresponding to sulfur in an XRPD pattern is about 23 degrees 2θ (±1 degree 2θ); the peak corresponding to silicon in an XRPD pattern is between 28 and 47 degrees 2θ (±1 degree 2θ); the peak corresponding to tin in an XRPD pattern is about 22 degrees 2θ (±1 degree 2θ).

Size

The size of the composite can affect its capacity retention. As used herein, “size” (or particle size) refers to the longest distance from edge to edge of the composite. Various factors affect the size of the composite. Size may vary depending, for example, on the type of mechanochemical processing (e.g., grinding versus stirring), as well as the parameters of the processing (e.g., frequency of grinding or stirring).

For example, when the mechanochemical grinding method described herein is employed, the composite produced may have a size less than 500 nm, less than 450 nm, less than 400 nm, less than 350 nm, less than 300 nm, less than 250 nm, or less than 200 nm; or between 20 nm to 500 nm, between 50 nm and 500 nm, between 50 nm and 250 nm, or between 50 nm and 100 nm. In certain embodiments, the mechanochemical grinding method described herein is used to produce composites having ZIFs. Thus, in one embodiment, the ZIF composite (e.g., S/ZIF, Si/ZIF, Sn/ZIF) may have a size less than 500 nm, less than 450 nm, less than 400 nm, less than 350 nm, less than 300 nm, less than 250 nm, or less than 200 nm; or between 20 nm to 500 nm, between 50 nm and 500 nm, between 50 nm and 250 nm, or between 50 nm and 100 nm.

When the mechanochemical stirring method described herein is employed, the resulting composite may have a size less than 20 microns, less than 10 microns, less than 5 microns, or less than 1 micron; or between 50 nm and 10 microns, between 50 nm and 20 microns, between 100 nm and 10 microns, between 200 nm and 10 microns, between 200 nm and 5 microns, or between 1 micron to 5 microns. In certain embodiments, the mechanochemical stirring method described herein is used to produce composites having MOFs or COFs. Thus, in one embodiment, the MOF or COF (e.g., S/MOF, Si/MOF, Sn/MOF, S/COF, Si/COF, Sn/COF) may have a size less than 20 microns, less than 10 microns, less than 5 microns, or less than 1 micron; or between 50 nm and 10 microns, between 50 nm and 20 microns, between 100 nm and 10 microns, between 200 nm and 10 microns, between 200 nm and 5 microns, or between 1 micron to 5 microns.

The use of sulfur versus silicon or tin for a given mechanochemical method (e.g. grinding or stirring) may also affect composite size. The methods involving sulfur may produce a composite having a size that is smaller than composites produced using methods involving silicon or tin. For example, in certain embodiments, the sulfur composite produced by grinding may have a size less than 500 nm, less than 450 nm, less than 400 nm, less than 350 nm, less than 300 nm, less than 250 nm, or less than 200 nm; or between 20 nm to 500 nm, between 50 nm and 500 nm, between 50 nm and 250 nm, or between 50 nm and 100 nm. In one embodiment, S/ZIFs (e.g., S/ZIF-8) produced by grinding may have a size less than 500 nm, less than 450 nm, less than 400 nm, less than 350 nm, less than 300 nm, less than 250 nm, or less than 200 nm; or between 20 nm to 500 nm, between 50 nm and 500 nm, between 50 nm and 250 nm, or between 50 nm and 100 nm.

Size of the composite may be determined using any suitable methods or techniques known in the art. For example, size may be determined by scanning electron microscope (SEM). One of skill in the art would recognize that the methods described herein may produce composites having a distribution of sizes.

Such size distribution may be expressed as an average size (e.g., average particle size). For example, when the mechanochemical grinding method described herein is employed, the composite may have an average size less than 500 nm, less than 450 nm, less than 400 nm, less than 350 nm, less than 300 nm, less than 250 nm, or less than 200 nm; or between 20 nm to 500 nm, between 50 nm and 500 nm, between 50 nm and 250 nm, or between 50 nm and 100 nm. In one embodiment, the ZIF composites produced (e.g., S/ZIFs, Si/ZIFs, Sn/ZIFs) may have an average size less than 500 nm, less than 450 nm, less than 400 nm, less than 350 nm, less than 300 nm, less than 250 nm, or less than 200 nm; or between 20 nm to 500 nm, between 50 nm and 500 nm, between 50 nm and 250 nm, or between 50 nm and 100 nm.

When the mechanochemical stirring method described herein is employed, the composite may have an average size less than 20 microns, less than 10 microns, less than 5 microns, or less than 1 micron; or between 50 nm and 10 microns, between 50 nm and 20 microns, between 100 nm and 10 microns, between 200 nm and 10 microns, between 200 nm and 5 microns, or between 1 micron to 5 microns. In one embodiment, the MOF or COF composite produced (e.g., S/MOFs, Si/MOFs, Sn/MOFs, S/COFs, Si/COFs, Sn/COFs) may have an average size less than 20 microns, less than 10 microns, less than 5 microns, or less than 1 micron; or between 50 nm and 10 microns, between 50 nm and 20 microns, between 100 nm and 10 microns, between 200 nm and 10 microns, between 200 nm and 5 microns, or between 1 micron to 5 microns.

The size distribution of the composite may be expressed as a D50 size distribution or a D90 size distribution. As used herein, “D50 size distribution” refers to the maximum diameter in which 50% of the composites (or composite particles) lies below the stated value (also referred to as the median). “D90 size distribution” refers to the maximum diameter below which 90% of the composites (or composite particles) lie below the stated value.

For example, when the mechanochemical grinding method described herein is employed, the composite produced may have a D50 size distribution between 20 nm and 100 nm. The composite produced may also have a D90 size distribution between 20 nm and 500 nm. For example, in one exemplary embodiment, S/ZIF produced by the mechanochemical grinding method may have a D90 size distribution of about 50 nm. In another example, Si/ZIF or a Sn/ZIF produced by the mechanochemical grinding method may have a D90 size distribution of about 200 nm.

When the mechanochemical stirring method described herein is employed, the composite produced may have a D50 size distribution between 50 nm and 10 microns. The composite produced may also have a D90 size distribution between 50 nm and 20 microns. For example, in an exemplary embodiment, Si/MOF or Sn/MOF produced by the mechanochemical stirring method may have a D90 size distribution about 1-2 microns.

Impurities

The composites provided herein or produced according to the methods described herein may have less than 25 wt %, less than 20 wt %, or less than 15 wt % of impurities. Such impurities may include, for example, oxides of sulfur, silicon or tin.

### Electrodes

The composites provided herein or produced according to the methods described herein may be suitable for use as electrode materials in batteries, such as Li-ion batteries. In one aspect, provided is an electrode comprising: a composite (or a plurality of the composites) provided herein or produced according to any of the methods described herein, carbonaceous material, and binder. In some embodiments of the electrode, the composite is at least 25 wt % or at least 30 wt % of the electrode. In some variations of the electrode, the composite is a MOF composite. In one variation of the electrode, the composite is a ZIF composite.

In some embodiments, provided is a cathode that includes: a sulfur composite (or a plurality of the sulfur composites) provided herein or produced according to any of the methods described herein, carbonaceous material, and binder. In some embodiments of the cathode, the composite is a S/MOF composite. In one variation of the electrode, the composite is a S/ZIF composite. In an exemplary embodiment, the cathode includes S/ZIF (e.g., S/ZIF-8), carbonaceous material, and binder.

In other embodiments, provided is an anode comprising: a silicon or tin composite (or a plurality of the silicon or tin composites) provided herein or produced according to any of the methods described herein, carbonaceous material, and binder. In some embodiments of the anode, the composite is a Si/MOF composite or a Sn/MOF composite. In one variation of the electrode, the composite is a Si/ZIF composite or a Sn/ZIF composite. In another exemplary embodiment, the anode includes Si/ZIF (e.g., Si/ZIF-8) or Sn/ZIF (e.g., Sn/ZIF-8), carbonaceous material, and binder.

In some variations of the foregoing embodiments of the cathode and anode, the MOF composite may be carbonized. For example, in certain variations of the anode, the composite is a carbonized Si/MOF composite or a carbonized Sn/MOF composite. In one variation of the electrode, the composite is a carbonized Si/ZIF composite or a carbonized Sn/ZIF composite.

Any carbonaceous materials known in the art suitable for use in preparing electrodes of batteries, including for example Li-ion batteries, may be used. For example, the carbonaceous material may be carbon black.

Any binders known in the art suitable for use in preparing electrodes of batteries, including for example Li-ion batteries, may be used. For example, the binder may be poly(vinylidene fluoride) (PVdF), carboxyl methyl cellulose (CMC), and alginate, or any combinations thereof.

Any suitable methods and techniques known in the art may be employed to prepare the cathode or anode. See e.g., Hong Li et al. Adv. Mater. 2009, 21, 4593-460.

It should be understood that the composites provided herein or produced according to any of the methods described herein functions as active material in the electrode. The composites in the electrode may be characterized by one or more properties, including for example charge/discharge capacity, decay rate, retention rate, and coulombic efficiency. One of skill in the art would recognize the suitable methods and techniques to measure capacity of the composite used in an electrode. For example, capacity may be measured by standard discharging and charging cycles, at standard temperature and pressure (e.g., 25° C. and 1 bar). See e.g., Juchen Guo, et al., J. Mater. Chem., 2010, 20, 5035-5040.

Discharge Capacity

As used herein, “discharge capacity” (also referred to as specific capacity) refers to the capacity measured to discharge the cell. Discharge capacity can also be described as the amount of energy the composite contains in milliamp hours (mAh) per unit weight.

In some embodiments, the composites provided herein or produced according to any of the methods described herein have an average discharge capacity over an initial 10 cycles of at least 500 mAh/g, at least 600 mAh/g, at least 700 mAh/g, at least 800 mAh/g, at least 900 mAh/g, or at least 1,000 mAh/g at 0.1 C. In some embodiments, the composites provided herein or produced according to any of the methods described herein have an average discharge capacity over an initial 10 cycles of at least 500 mAh/g, at least 600 mAh/g, at least 700 mAh/g, at least 800 mAh/g, at least 900 mAh/g, or at least 1,000 mAh/g at 0.5 C. For example, in certain embodiments, the composites provided herein or produced according to the methods described herein have an average discharge capacity over an initial 10 cycles of: (i) at least 900 mAh/g at 0.1 C; and (ii) at least 700 mAh/g at 0.5 C.

For example, in one example, S/ZIF provided herein or produced according to the methods described herein (e.g., S/ZIF-8) have an average discharge capacity over an initial 10 cycles of: (i) at least 1,000 mAh/g at 0.1 C; and (ii) at least 800 mAh/g at 0.5 C. In another example, S/MOF (e.g., S/MIL-53, S/NH₂-MIL-53) or S/COF provided herein or produced according to the methods described herein has an average discharge capacity over an initial 10 cycles of: (i) at least 700 mAh/g at 0.1 C; and (ii) at least 600 mAh/g at 0.5 C. It should be understood that 0.1 C and 0.5 C refers to different charging rates.

In some aspects, provided herein is an electrode material, e.g., for use in a lithium ion battery, that includes a calcined or carbonized composite, wherein the composite comprises a plurality of metal oxide particles dispersed in a carbon matrix having one or more pores, wherein sulfur, silicon or tin occupies at least a portion of the one or more pores in the carbon matrix. In some variations of any of the foregoing embodiments, the electrode material has a discharge capacity over an initial 50 cycles of at least 900 mAh/g, or at least 950 mAh/g, or at least 1000 mAh/g, or between 750 mAh/g and 1100 mAh/g, or between 800 mAh/g and 1100 mAh/g, or between 900 mAh/g and 1100 mAh/g, or between 950 mAh/g and 1050 mAhg/, at room temperature when discharged from 3.0 V to 20 mV after the material is activated in the first cycle through a charge to 3.0 Vat a rate of 0.1 mV/s.

In some variations, the electrode material is an anode material, and the calcined or carbonized composite includes silicon or tin. In one variation, the calcined or carbonized composite includes silicon. The calcined or carbonized composite of the electrode material may be prepared according to the mechanochemical processing methods described herein.

In one variation where the electrode material is a cathode material having the discharge properties described above, the composite includes sulfur. In another variation that may be combined with the foregoing variation, the composite includes zinc oxide particles dispersed in a porous carbon matrix.

In another variation where the electrode material is an anode material having the discharge properties described above, the composite includes silicon. In another variation that may be combined with the foregoing variation, the composite includes aluminum oxide (alumina) particles dispersed in a porous carbon matrix.

Decay Rate

As used herein, “decay rate” refers to the decrease in capacity as a function of given number of cycles. In some embodiments, the composite provided herein or produced according to any of the methods described herein has a decay rate at 0.5 C of less than 0.2%, or less than 0.1% per cycle.

Retention Rate

As used herein, “retention rate” refers to the capacity retained after 200-300 cycles, calculated as Q/Qᵢₙᵢₜᵢₐₗ. In some embodiments, the composites provided herein or produced according to any of the methods described herein have an average retention rate after 200 cycles of at least 60%, at least 65%, at least 70%, or at least 80%. In some embodiments, the composites provided herein or produced according to any of the methods described herein have an average rate after 300 cycles of at least 40%, at least 50%, at least 60% or at least 70%. For example, in one exemplary embodiment, the composites provided herein or produced according to any of the methods described herein have an average retention rate after 200-300 cycles of at least 70%.

Coulombic Efficiency

As used herein, “coulombic efficiency” refers to the ratio of discharging over charging capacity. A high coulombic efficiency is desired (e.g., at or near 100%), which would indicate that the amount of charge going in is equal or close to equal the amount of charge coming out. Further, consistency of coulombic efficiency over cycles is desired, which would allow for consumption of less electrolytes and power in, for example, a battery, and provide better prediction of when the battery is charged and discharged.

The composites provided herein or produced according to any of the methods described herein have a coulombic efficiency that is significantly better than materials known in the art. Such improved coulombic efficiency may be due to various factors, including for example, the monodispersion and improved contact of the sulfur, silicon or tin with the open frameworks, conductive components and the electrolytes. Additionally, improved coulombic efficiency may be due to the size of the composites that result from the methods provided herein, as the diffusion path of electrolyte and sulfur, silicon or tin may be shorter and thus more efficient.

In some embodiments, the composites provided herein or produced according to any of the methods described herein have an average coulombic efficiency of at least 60%, at least 70%, at least 80%, at least 90% or at least 95%. Such coulombic efficiency may, in certain embodiments, be achieved over at least 10 cycles. For example, in one embodiment, the composites have an average coulombic efficiency over about 30 cycles of at least 80%, at least 90%, or at least 95%.

### Batteries

The electrodes described herein may be used in a battery, including for example lithium-ion (Li-ion) batteries. Thus, in one aspect, provided is a Li-ion battery that includes: (i) an electrode, wherein the electrode includes a composite (or a plurality of composites) provided herein or produced according to any of the methods described herein, carbonaceous material, and binder; and (ii) lithium ions. In some variations of the battery, the composite used in the electrode is a carbonized composite.

In some embodiments, provided is a battery (e.g., a Li-ion battery) that includes: (i) a cathode, wherein the cathode includes a sulfur composite (or a plurality of sulfur composites) provided herein or produced according to any of the methods described herein, carbonaceous material, and binder; and an anode. In an exemplary embodiment, the cathode of the Li-ion battery includes S/ZIF (e.g., S/ZIF-8).

In other embodiments, provided is a battery (e.g., a Li-ion battery) that includes: (i) an anode, wherein the anode comprises a silicon or tin composite (or a plurality of silicon or tin composites) provided herein or produced according to any of the methods described herein, carbonaceous material, and binder; and (ii) a cathode. In an exemplary embodiment, the anode of the Li-ion battery includes Si/ZIF (e.g., Si/ZIF-8) or Si/MOF (e.g., Si-MOF-5). In another exemplary embodiment, the anode of the Li-ion battery includes Sn/ZIF (e.g., Sn/ZIF-8) or Sn/MOF (e.g., Sn/MOF-5). In one variation, the anode of the Li-ion battery includes carbonized Si/ZIF (e.g., carbonized Si/ZIF-8) or carbonized Si/MOF (e.g., carbonized Si-MOF-5). In another exemplary embodiment, the anode of the Li-ion battery includes carbonized Sn/ZIF (e.g., carbonized Sn/ZIF-8) or carbonized Sn/MOF (e.g., carbonized Sn/MOF-5).

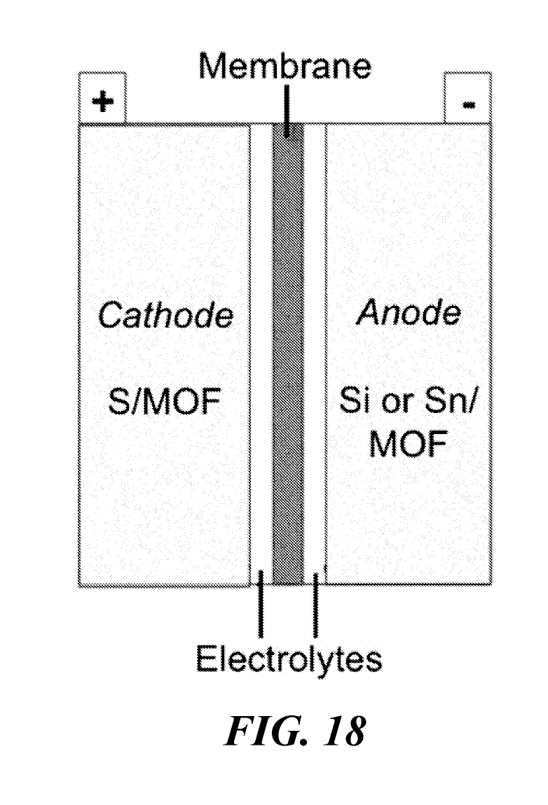

With reference to FIG. 18, an exemplary battery is depicted. In this exemplary battery, the cathode is made up S/MOF, as described herein. The anode is also made up of Si/MOF or Sn/MOF, as described herein. It should be understood, however, that while both electrodes are depicted as having composites as described herein in other exemplary batteries, the battery may include a cathode made up of S/MOF, and an anode without Si/MOF or Sn/MOF; or the battery may include an anode made up of the Si/MOF or Sn/MOF composite, and a cathode without S/MOF. Further, it should also be understood that while MOF composites are depicted in the exemplary battery, other open framework composites (e.g., S/ZIFs, S/COFs, Si/ZIFs, Si/COFs, Sn/ZIFs, Sn/COFs) as described herein may be used as electrode materials.

With reference again to FIG. 18, the exemplary battery may include any suitable membrane or other separator that separates the cathode and anode, while allowing ions to pass through. The electrodes and the membrane are submerged in an electrolyte. Any suitable electrolytes may be used in the battery. For example, in Li-ion batteries, the electrolytes may be bis-(trifluoromethanesulfonyl)imide lithium (LiTFSI), LiNO₃, and/or lithium hexafluorophosphate (LiPF6) in solvents or solvent mixtures (e.g., organic solvent or solvent mixtures that may include carbonates, carboxylates, esters and/or ethers). When the battery charges, the ions (e.g., lithium ions in the case of a Li-ion battery) move through the electrolyte from the cathode to anode. During discharge, the ions move back to the cathode.

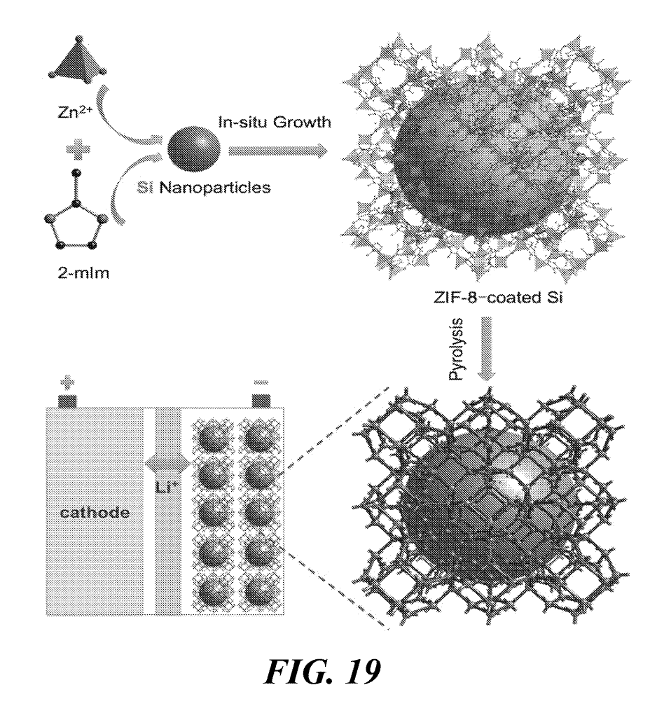

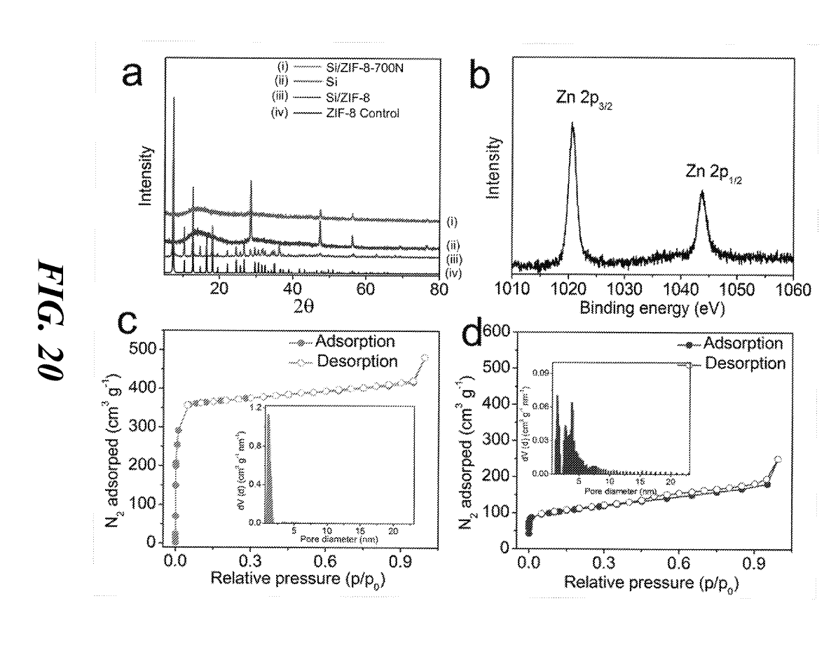

In some aspects, provided herein is also a method for preparing an electrode material suitable for use in a battery. For example, with reference to FIG. 19, an exemplary process to prepare an anode material with carbonized Si/ZIF-8 is depicted. In the first step, Si/ZIF-8 may be prepared by mechanochemically processing (i) 2-methyl imidazole (2-mIm), (ii) Zn²⁺, which may, for example, be provided in the form of zinc oxide, and (iii) silicon nanoparticles to produce Si/ZIF-8. In the second step, the Si/ZIF-8 may be carbonized, for example, by pyrolysis, to produce carbonized Si/ZIF-8, which is a composite of amorphous carbon with mono-dispersed zinc ions formed around Si. This carbonized composite may be combined, for example, with carbon and binder in the preparation of an anode material. In other aspects, the exemplary process depicted in FIG. 19 may be employed to prepare anode materials using other MOFs in combination with either silicon or tin.

Similarly, a cathode material with carbonized S/MOFs can be also prepared using a similar process to the one depicted in FIG. 19. For example, in the first step, S/ZIF-8 may be prepared by mechanochemically processing (i) 2-methyl imidazole (2-mIm), (ii) Zn²⁺, which may, for example, be provided in the form of zinc oxide, and (iii) sulfur nanoparticles to produce S/ZIF-8. In the second step, the S/ZIF-8 may be carbonized, for example, by pyrolysis, to produce carbonized S/ZIF-8. This carbonized composite may be combined, for example, with carbon and binder in the preparation of a cathode material. In other variations, only the first step is performed, and the composite of ZIF-8 coated with S may be used to prepare the cathode material.

The batteries, including for example Li-ion batteries, described above may be suitable for use in portable wireless devices (e.g., cell phones) and electric vehicles. Other forms of batteries that may use the composites include, for example, metal-air batteries. The composites provided herein may also be suitable for use as the active electrode materials in fuel cells and super capacitors (e.g., pseudo-capacitors, hybrid capacitors, and Faradaic capacitors).

### Enumerated Embodiments

The following enumerated embodiments are representative of some aspects of the invention.

1. A method for producing a composite, comprising mechanochemically processing (i) one or more organic linking compounds, (ii) one or more metal compounds, and (iii) sulfur, silicon or tin to produce the composite.
2. The method of embodiment 1, wherein the composite comprises an open framework produced from the one or more organic linking compounds and the one or more metal compounds, and

wherein the open framework has one or more pores, and

wherein the sulfur, silicon or tin occupies at least a portion of the one or more pores.

3. The method of embodiment 1 or 2, further comprising heating the composite.
4. The method of any one of embodiments 1 to 3, wherein the mechanochemical processing is performed by grinding.
5. The method of embodiment 4, wherein the grinding is performed without external heating.
6. The method of embodiment 4 or 5, wherein the grinding is performed using a ball mill.
7. The method of any one of embodiments 4 to 6, wherein the composite has an average size less than 500 nm.
8. The method of embodiment 7, wherein the composite has an average size between 20 nm and 500 nm.
9. The method of any one of embodiments 1 to 3, wherein the mechanochemical processing is performed by stirring.
10. The method of embodiment 9, wherein the stirring is performed at room temperature.
11. The method of embodiment 9 or 10, wherein the composite has an average size less than 10 microns.
12. The method of embodiment 11, wherein the composite has an average size between 200 nm and 10 microns.
13. The method of any one of embodiments 1 to 12, wherein the composite has an X-ray powder diffraction (XRPD) pattern wherein the peak corresponding to sulfur, silicon or tin has an intensity less than 100 (a.u.).
14. The method of any one of embodiments 1 to 13, wherein the open framework is a metal-organic framework (MOF) or covalent organic framework (COF).
15. The method of embodiment 14, wherein the one or more organic linking compounds are independently:

an aryl with at least one phenyl ring substituted with at least one —COOH moiety, or

a heteroaryl with at least pyridyl ring substituted with at least one —COOH moiety.

16. The method of embodiment 14, wherein the one or more organic linking compounds are independently an aromatic ring system with at least one phenyl ring optionally substituted with alkyl, or an aromatic ring system coordinating to or chelating with a tetrahedral atom, or forming a tetrahedral group or cluster.
17. The method of any one of embodiments 1 to 13, wherein the open framework is a zeolitic imidazolate framework (ZIF).
18. The method of embodiment 17, wherein the one or more organic linking compounds are independently:

a monocyclic five-membered heteroaryl having at least two nitrogen atoms, wherein two of the nitrogen atoms are configured in the 1- and 3-positions of the monocyclic five-membered ring, or

a bicyclic ring system made up of at least one five-membered ring having at least two nitrogen atoms, wherein two of the nitrogen atoms are configured in the 1- and 3-positions of the five-membered ring.

19. The method of any one of embodiments 1 to 13, wherein the open framework is ZIF-8, HKUST-1, MIL-53, NH₂-MIL-53, or MOF-5.
20. The method of any one of embodiments 1 to 19, wherein the one or more metal compounds independently comprise Mg²⁺, Ca²⁺, Sr²⁺, Ba²⁺, Sc³⁺, Y³⁺, Ti⁴⁺, Zr⁴⁺, Hf⁴⁺, V⁴⁺, V³⁺, V²⁺, Nb³⁺, Ta³⁺, Cr³⁺, Mo³⁺, W³⁺, Mn³⁺, Mn²⁺, Re³⁺, Re²⁺, Fe³⁺, Fe³⁺, Ru³⁺, Ru²⁺, Os³⁺, Os²⁺, Co³⁺, Co²⁺, Rh²⁺, Rh⁺, Ir²⁺, Ir⁺, Ni²⁺, Ni⁺, Pd²⁺, Pd⁺, Pt²⁺, Pt⁺, Cu²⁺, Cu⁺, Ag⁺, Au⁺, Zn²⁺, Cd²⁺, Hg²⁺, Al³⁺, Ga³⁺, In³⁺, Tl³⁺, Si⁴⁺, Si²⁺, Ge⁴⁺, Ge²⁺, Sn⁴⁺, Sn²⁺, Pb⁴⁺, Pb²⁺, As⁵⁺, As³⁺, As⁺, Sb⁵⁺, Sb³⁺, Sb⁺, Bi⁵⁺, Bi³⁺, or Bi⁺.
21. The method of any one of embodiments 1 to 20, wherein sulfur is used to produce the composite.
22. The method of any one of embodiments 1 to 20, wherein silicon or tin is used to produce the composite.
23. The method of embodiment 21 or 22, further comprising calcining or carbonizing the composite.
24. A composite produced according to any one of embodiments 1 to 23.
25. A composite comprising a metal-organic framework (MOF) or a covalent organic framework (COF) having one or more pores, wherein:

sulfur, silicon or tin occupies at least a portion of the one or more pores,

the composite has an average size less than 10 microns, and

the composite has an X-ray powder diffraction (XRPD) pattern wherein the peak corresponding to sulfur, silicon or tin has an intensity less than 100 (a.u.).

26. The composite of embodiment 25, wherein the MOF is a zeolitic imidazolate framework (ZIF), and the composite has an average size less than 500 nm.
27. The composite of embodiment 25, wherein the open framework is ZIF-8, HKUST-1, MIL-53, NH₂-MIL-53, or MOF-5.
28. The composite of any one of embodiments 25 to 27, wherein the open framework is ZIF-8, and the composite has an average discharge capacity over an initial 10 cycles of: (i) at least 900 mAh/g at 0.1 C; and (ii) at least 700 mAh/g at 0.5 C, or both (i) and (ii).
29. The composite of any one of embodiments 25 to 28, wherein the composite has a decay rate at 0.5 C of less than 0.1% per cycle.
30. The composite of any one of embodiments 25 to 29, wherein the composite has an average retention rate after 200 cycles of at least 70%.
31. The composite of any one of embodiments 25 to 30, wherein the composite has an average coulombic efficiency over 30 cycles of at least 80%.
32. An electrode, comprising:

a composite of any one of embodiments 25 to 31;

carbonaceous material; and

binder.

33. The electrode of embodiment 32, wherein the electrode is a cathode, and the composite comprises sulfur.
34. The electrode of embodiment 32, wherein the electrode is an anode, and the composite comprises silicon or tin.
35. A battery, comprising:

a cathode of embodiment 33, an anode of embodiment 34, or both; and

lithium ions.

36. An electrode material for a lithium ion battery, comprising:

a calcined or carbonized composite, wherein the composite comprises a plurality of metal oxide particles dispersed in a carbon matrix having one or more pores, wherein sulfur, silicon or tin occupies at least a portion of the one or more pores in the carbon matrix; and

wherein the electrode material has a discharge capacity over an initial 50 cycles of at least 900 mAh/g at room temperature when discharged from 3.0 V to 20 mV after the material is activated in the first cycle through a charge to 20 mV at a rate of 0.1 mV/s.

37. The electrode material of embodiment 36, wherein the plurality of metal oxide particles are uniformly dispersed in a carbon matrix having one or more pores.
38. The electrode material of embodiment 36 or 37, wherein the calcined or carbonized composite is obtained by a method comprising:

mechanochemically processing (i) one or more organic linking compounds, (ii) one or more metal compounds, and (iii) sulfur, silicon or tin to produce a metal organic framework (MOF) composite; and

calcining or carbonizing the MOF composite to produce the calcined or carbonized composite.

39. The electrode material of embodiment 38, wherein the one or more organic linking compounds are independently:

an aryl with at least one phenyl ring substituted with at least one —COOH moiety, or

a heteroaryl with at least pyridyl ring substituted with at least one —COOH moiety.

40. The electrode material of embodiment 38, wherein the one or more organic linking compounds are independently an aromatic ring system with at least one phenyl ring optionally substituted with alkyl, or an aromatic ring system coordinating to or chelating with a tetrahedral atom, or forming a tetrahedral group or cluster.
41. The electrode material of embodiment 38, wherein the metal organic framework is a zeolitic imidazolate framework (ZIF).
42. The electrode material of embodiment 38, wherein the one or more organic linking compounds are independently:

a monocyclic five-membered heteroaryl having at least two nitrogen atoms, wherein two of the nitrogen atoms are configured in the 1- and 3-positions of the monocyclic five-membered ring, or

a bicyclic ring system made up of at least one five-membered ring having at least two nitrogen atoms, wherein two of the nitrogen atoms are configured in the 1- and 3-positions of the five-membered ring.

43. The electrode material of embodiment 38, wherein the metal organic framework is ZIF-8, HKUST-1, MIL-53, NH₂-MIL-53, or MOF-5.
44. The electrode material of embodiment 38, wherein the one or more metal compounds independently comprise Mg²⁺, Ca²⁺, Sr²⁺, Ba²⁺, Sc³⁺, Y³⁺, Ti⁴⁺, Zr⁴⁺, Hf⁴⁺, V⁴⁺, V³⁺, V²⁺, Nb³⁺, Ta³⁺, Cr³⁺, Mo³⁺, W³⁺, Mn³⁺, Mn²⁺, Re³⁺, Re²⁺, Fe³⁺, Fe³⁺, Ru³⁺, Ru²⁺, Os³⁺, Os²⁺, Co³⁺, Co²⁺, Rh²⁺, Rh⁺, Ir²⁺, Ir⁺, Ni²⁺, Ni⁺, Pd²⁺, Pd⁺, Pt²⁺, Pt⁺, Cu²⁺, Cu⁺, Ag⁺, Au⁺, Zn²⁺, Cd²⁺, Hg²⁺, Al³⁺, Ga³⁺, In³⁺, Tl³⁺, Si⁴⁺, Si²⁺, Ge⁴⁺, Ge²⁺, Sn⁴⁺, Sn²⁺, Pb⁴⁺, Pb²⁺, As⁵⁺, As³⁺, As⁺, Sb⁵⁺, Sb³⁺, Sb⁺, Bi⁵⁺, Bi³⁺, or Bi⁺.
45. The electrode material of any one of embodiments 36 to 44, wherein the calcined or carbonized composite comprises sulfur, and the electrode material is a cathode material.
46. The electrode material of any one of embodiments 36 to 44, wherein the calcined or carbonized composite comprises silicon or tin, and the electrode material is an anode material.
47. The electrode material of embodiment 46, wherein the calcined or carbonized composite comprises silicon.
48. A lithium ion battery comprising:

a cathode comprising the cathode material of embodiment 45;

an anode; and

a separator between the cathode and anode.

49. A lithium ion battery comprising:

a cathode;

an anode, or an anode comprising the anode material of embodiment 46 or 47; and

a separator between the cathode and anode.

50. A lithium ion battery comprising:

a cathode comprising the cathode material of embodiment 45;

an anode, or an anode comprising the anode material of embodiment 46 or 47; and

a separator between the cathode and anode.

### EXAMPLES

The following Examples are merely illustrative and are not meant to limit any aspects of the present disclosure in any way.

### Example 1

### Synthesis, Characterization and Use of Various S/MOFs

This Example demonstrates the synthesis, characterization and use of the following composites of MOFs encapsulating sulfur (S/MOFs): S/ZIF-8, S/MIL-53, S/HKUST-1 and S/NH₂-MIL-53. These MOFs represent open frameworks with a variety of characteristics, such as cage-type pores with small apertures (ZIF-8), unsaturated metal sites (HKUST-1), breathing network (MIL-53 and NH₂-MIL-53) and functionality (NH₂-MIL-53). They also have reasonable thermal and chemical stability toward sulfur and other chemicals involved in the synthetic process and electrochemical test.

### Synthesis

A metal compound was mixed with an organic linking compound, and ball-milled with 200 mg sulfur under argon for 30 min, and then subjected to a heating process under argon for 12 h. For the four reactions performed in this Example, the type and amounts of the metal compound and the organic linking compound are specified in Table 1 below. The heating temperatures for the four MOFs are also specified in Table 1 below.

As a control, ZIF-8, MIL-53, HKUST-1 and NH₂-MIL-53 were prepared according to procedures known in the art. See e.g., K. S. Park, et al., PNAS, 103 (27), 10186-10191 (2006); Stephen S.-Y. Chiu, et al., Science 283, 1148 (1999); T. Loiseau, et al., Chem. Eur. J., 10, 1373-1382 (2004). All the degassed MOFs and S/MOF samples were kept in an argon-filled glove box prior use.

TABLE 1

| | Metal | Organic Linking | | |
|---|---|---|---|---|
| No. | Compound | Compound | Temperature | S/MOF |
| 1 | ZnO | 2-methyl imidazole | 155° C. | S/ZIF-8 |
| | (120 mg) | (100 mg) | | |
| 2 | Cu(Ac)₂ | trimesic acid | 155° C. | S/MIL-53 |
| | (135 mg) | (45 mg) | | |
| 3 | Al(Ac)₃ | terephthalic acid | 140° C. | S/HKUST-1 |
| | (75 mg) | (175 mg) | | |
| 4 | Al(Ac)₃ | 2-amino benzyl | 140° C. | S/NH₂-MIL-53 |
| | (80 mg) | dicarboxylic acid | | |
| | | (210 mg) | | |

### Characterization

The structure and morphology of the samples were characterized by X-ray powder diffraction (XRPD, Rigaku D/max 2000 diffractometer, Cu Kα) and scanning electron microscope (SEM, Hitachi S4800). See FIGS. 2-4. The XRPDs indicated that the MOF structures were well-maintained during the heating step. Additionally, the characteristic peak for bulk crystalline sulfur became almost undetectable after the heating step, indicating that most sulfur has been successfully incorporated into the MOF channels. Large sulfur agglomerates were not observed, as seen by the SEM images.

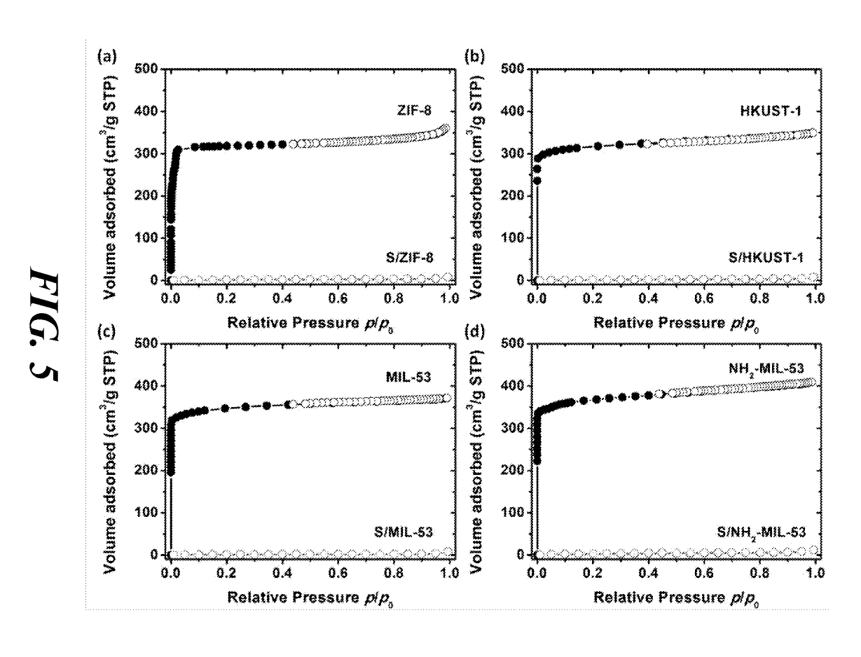

The incorporation of sulfur in the pores of the MOFs was also investigated by nitrogen sorption measurements. Nitrogen adsorption-desorption isotherms were measured on a COULTER SA 3100 apparatus at 77 K. Before the measurement, MOF samples were degassed with reported procedures. See e.g., Park, K. S., et al., Proc. Natl. Acad. Sci. 2006, 103, 10186; Rowsell, J. L. C. & Yaghi, O. M., J. Am. Chem. Soc. 2006, 128, 1304; and Pera-Titus, M., et al., D. J. Phys. Chem. C 2012, 116, 9507. S/MOF samples were measured immediately after leaving the glove box. See FIG. 5. The MOFs showed significant loss in specific surface areas and pore volumes after incorporation of the sulfur.

The sulfur contents, both calculated by the mass changes before and after heat treatment, were measured by thermal gravimetric analysis (TGA). The TGA was carried out on a Q600 SDT thermoanalyzer (Thermal Analysis Corporation, USA) in N₂ with a heating rate of 10° C./min: all samples were tested immediately after leaving the glove box. See FIG. 6.

### Electrochemical Test

To gauge the abilities of the four S/MOFs produced in this Example to immobilize polysulfides, coin cells with a metallic Li anode were assembled. To prepare the cathodes, 60 wt % of each of the four S/MOFs prepared in this Example, 30 wt % conductive carbon black (CB) and 10 wt % poly(vinylidene fluoride) (PVdF) binder were mixed in N-methyl-2-pyrrolidinone (NMP) to form a slurry. The slurry was then coated on aluminium current collectors and dried at 60° C. over 24 h. Coin cells of 2032-type with a metallic Li anode were assembled. 0.6M bis-(trifluoromethanesulfonyl)imide lithium (LiTFSI) in 1,2-dimethoxyethane (DME) and 1,3-dioxolane (DOL) (v/v 1:1) was used as the electrolyte with 0.1M LiNO₃ as an additive to passivate the surface of the Li anode. This electrolyte was chosen for its low viscosity and favorability for electrolyte accessibility to the sulfur within the porous systems.

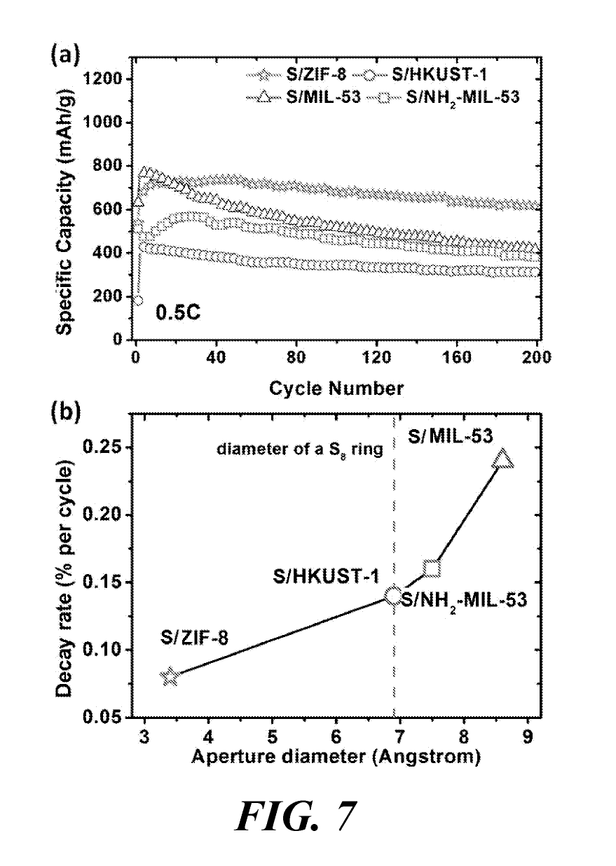

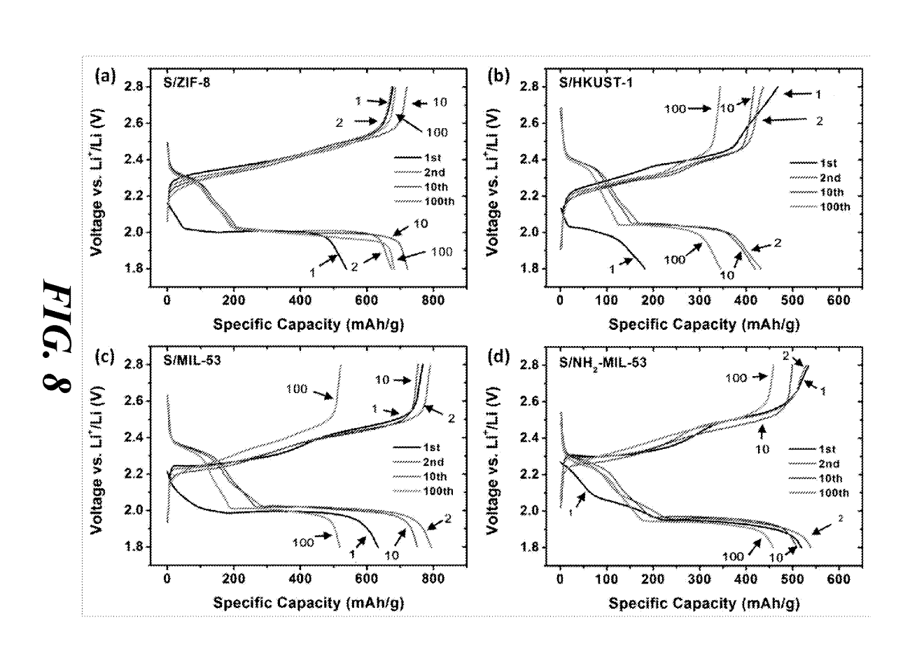

The batteries were cycled between 1.8 and 2.8 V at a constant discharge/charge rate of 0.5 C over 200 cycles to examine their long-term cyclabilities. See FIGS. 7(a) and 8. The S/MOFs were observed to exhibit an activation process in the initial period. The maximum discharge capacities achieved during the cycling process were observed to be: 431, 568, 738 and 793 mAh/g (based on sulfur) for S/HKUST-1, S/NH₂-MIL-53, S/ZIF-8 and S/MIL-53, respectively. After the initial stages for adaption, all S/MOFs showed high capacity retention over prolonged cycling.

As seen in FIG. 7(b), the fading in S/MOF seemed to be correlated to the aperture diameter of the pores of the S/MOFs. The diameters of the largest aperture in ZIF-8, HKUST-1, NH₂-MIL-53 and MIL-53 are 3.4 Å, 6.9 Å, 7.5 Å and 8.5 Å, respectively, corresponded to the average decay rates at 0.5 C of 0.08%, 0.14%, 0.16%, and 0.24% per cycle.

With reference again to FIG. 8, the four S/MOFs were observed to undergo a two-plateau behavior. The upper plateau (2.3˜2.4 V) corresponded to the reduction of element sulfur to dissolved long-chain polysulfides, and the lower plateau (˜2.0 V) corresponded to the further reduction and formation of insoluble products (Li₂S₂ and Li₂S).

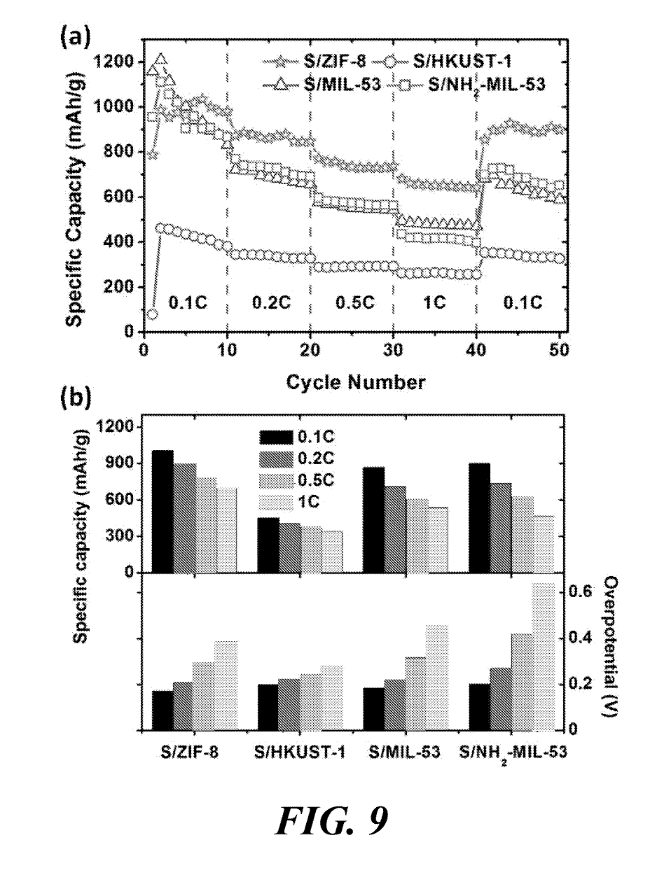

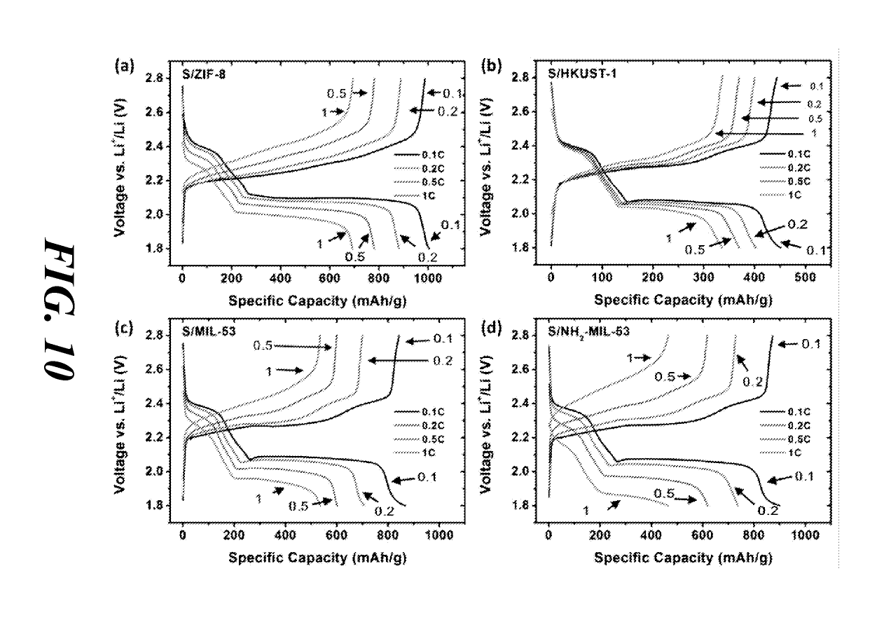

Cycling tests at various discharge/charge rates were also performed. See FIGS. 9(a) and 10. The evolutions of reversible capacities and overpotentials during the increase of current density were used to evaluate the relative importance between mass transport and charge transfer. See FIG. 9(b). Overpotential is the voltage gap between 50% depth of charge (DOC) and 50% depth of discharge (DOD) of each cycle.

As seen in FIG. 9(a), a discharge capacity over 1,000 mAh/g was observed for S/ZIF-8, S/NH₂-MIL-53 (Al) and S/MIL-53 (Al). As seen in FIG. 9(b), compared with S/MIL-53, the amino groups in S/NH₂-MIL-53 increase the tortuosity of the S/MOF channels, possibly hindering the diffusion of polysulfides to some extent, as suggested by a slightly higher overpotential. When the current density increases, charge transfer was observed to be more important. For example, as seen in FIG. 9(b), S/NH₂-MIL-53 was observed to have a sharp rise in overpotential and a rapid drop in reversible capacity. In contrast, the unsaturated metal sites in S/HKUST-1 were observed to stabilize the polysulfide phase, rendering only a minute decrease in capacity and increase in overpotential. S/ZIF-8 was observed to have moderate mass transport and charge transfer, leading to reasonable discharge capacities at all current rates.

Thus, this Example demonstrates the use of the S/MOFs as polysulfide reservoirs in Li—S batteries.

### Example 2

### Synthesis, Characterization and Use of Si/ZIF Composite

This Example demonstrates the synthesis, characterization and use of an exemplary ZIF encapsulating silicon (Si/ZIF-8).

### Synthesis

Zinc oxide (0.407 g), 2-methyl imidazole (0.8211 g) and Si (0.14 g) were combined in a steel tank, with five steel balls, and the contents were milled at high speed for 15 min. Then, 500 μL methanol was added into the tank, and the contents were milled for another 15 min. The resulting products were washed with methanol (30 mL) for three times and dried at 85° C.

### Characterization

The structure and morphology the product was characterized by X-ray powder diffraction, taken using monochromatized Cu-Kα (λ=1.54178 Å) incident radiation by a D8 Advance Bruker powder diffractometer operating at 40 kV voltage and 50 mA current. See FIG. 11.

### Electrochemical Test

To prepare the anodes, 60 wt % of the Si/MOF composite prepared in this Example, 30 wt % Super P carbon black, and 10 wt % CMC binder were mixed in water to form a slurry. The slurry was cast onto copper foil and dried under a vacuum at 120° C. for 12 h. Coin cells of CR2032 type were constructed inside an argon-filled glove box using a lithium metal foil as the negative electrode and the composite positive electrode separated by polypropylene microporous separator (Celgard). The electrolyte used was 1 M LiPF₆ in ethyl carbonate (EC) and diethyl carbonate (DMC) and EMC Ethyl methyl carbonate (1:1:1 in v/v).

Assembled coin cells were allowed to soak overnight and then were charged and discharged galvanostatically at 50 mA/g between 0.02 and 3.0 V using a Land battery tester at ambient temperature.

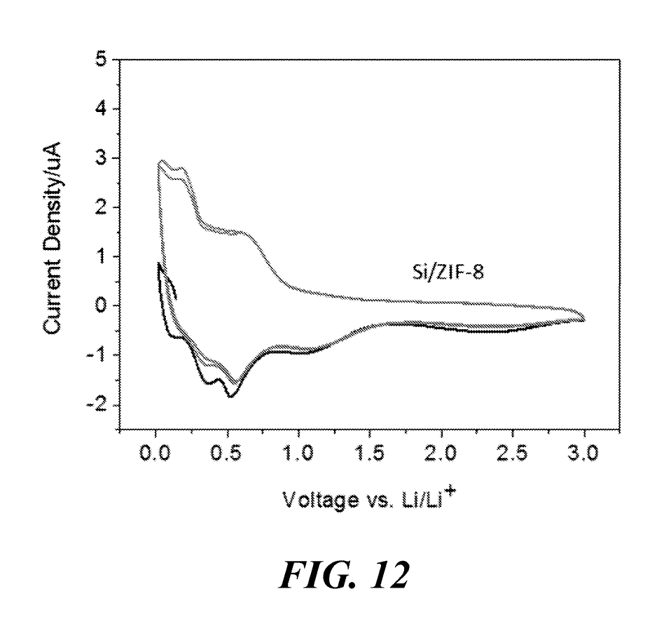

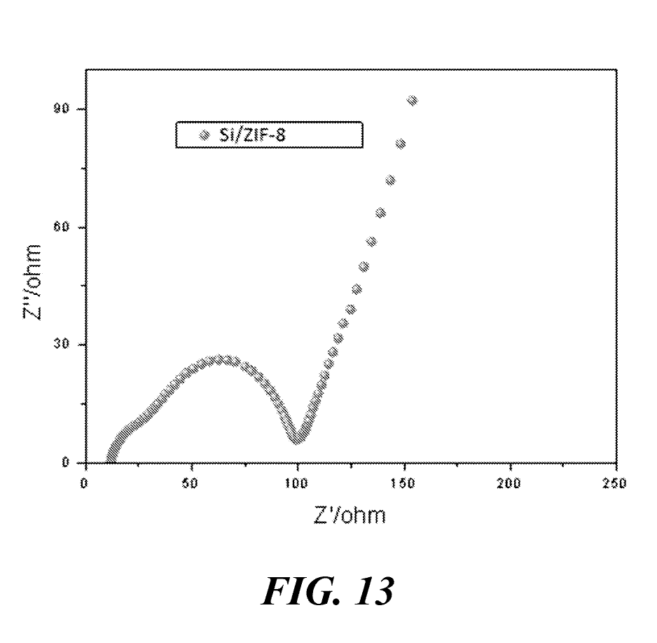

As seen in FIG. 12, Si/ZIF-8 have redox peaks from 0.2V to 0.5 V, making such a material suitable for use as anode materials in lithium ion batteries. As seen in FIG. 13, the AC impedance measurement indicates the cell assembled using Si/ZIF-8 has low internal resistance.

### Example 3a

### Synthesis, Characterization and Use of Si/MOF Composites

This Example demonstrates the synthesis, characterization and use of exemplary MOFs encapsulating silicon (Si/MOF composite), including Si/ZIF-8 and Si/MOF-5.

### Synthesis

Zinc oxide (0.814 g), 2-methyl imidazole (1.6422 g) and power Si (0.14 g) were put in a steel tank (the molar ratio is 1:2:0.5) with five steel balls, and milled at high speed (approximately 50 Hz) for 15 min. Then 1500 μL methanol was added into the tank, and ball milling was continued for another 15 min. The products were washed with methanol (30 mL) for three times and then dried at 85° C. for 5 h.

Terephthalic acid (1.013 g) and triethylamine (1.7 mL) were dissolved in 80 mL of DMF. Then 0.43 g Si were added and stirred for 15 min. Zn(OAc)₂.2H₂O (3.40 g) was dissolved in 100 mL of DMF. The zinc salt solution was added to the organic solution with stirring over 15 min, forming a precipitate, and the mixture was stirred for 2.5 h. The precipitate was filtered and immersed in DMF (250 mL) overnight. It was then filtered again and immersed in CHCl₃ (70 mL). The solvent was exchanged 3 times over 3 days. Then it was dried at 85° C. for 5 h.

The Si/ZIF-8 and Si/MOF-5 prepared above were then carbonized. The composites were transferred to a tube furnace and were heat-treated at target temperature for 1 h under nitrogen with a heating rate of 5° C./min to pyrolyze the ZIFs. Then the materials were cooled down to room temperature naturally. The target temperature was 700° C. and 550° C. for Si/ZIF-8 or Si/MOF-5, respectively.

### Characterization

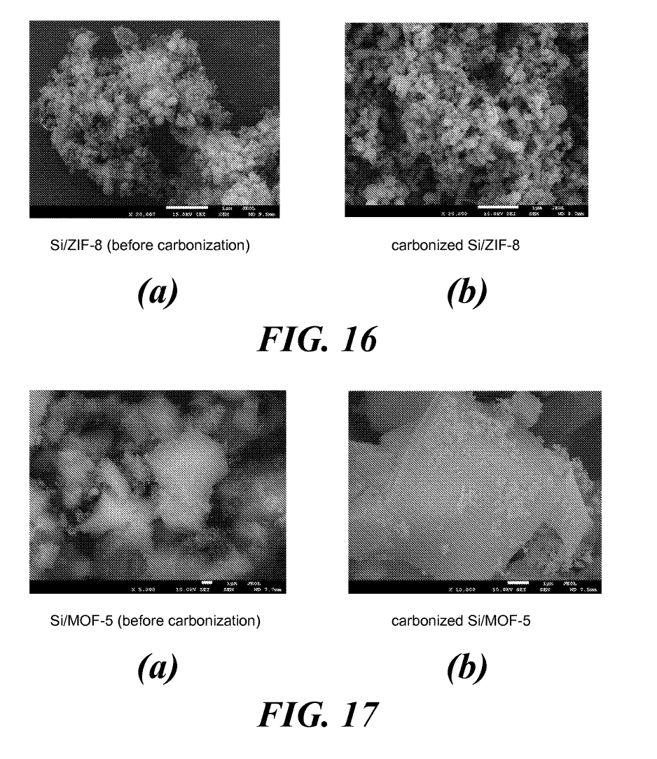

Scanning electron microscopy (SEM) was performed using a JSM7000 instrument (JEOL). The SEM images for the Si/ZIF-8, before and after carbonization, are shown in FIGS. 16(a) and (b), respectively. The SEM images for the Si/MOF-5, before and after carbonization, are shown in FIGS. 17(a) and (b), respectively.

X-ray photoelectron spectroscopy (XPS) was performed on the Thermo Scientific ESCALab 250Xi using 200 W monochromated Al Kα radiation. The 500 μm X-ray spot was used for XPS analysis. The base pressure in the analysis chamber was about 3×10⁻¹⁰ mbar. Typically the hydrocarbon C1s line at 284.8 eV from adventitious carbon is used for energy referencing. Tables 1a and 1b below summarize the XPS data for the Si/ZIF-8, before and after carbonization, respectively. Tables 2a and 2b below summarize the XPS data for the Si/MOF-5, before and after carbonization, respectively.

TABLE 1a

| Element | Wt % | At % |
|---|---|---|
| CK | 56.09 | 70.95 |
| NK | 13.62 | 14.77 |
| OK | 07.78 | 07.38 |
| ZnL | 17.14 | 03.98 |
| SiK | 05.38 | 02.91 |
| Matrix | Correction | ZAF |

TABLE 1b

| Element | Wt % | At % |
|---|---|---|
| CK | 21.00 | 38.18 |
| NK | 04.95 | 07.72 |
| OK | 03.97 | 05.42 |
| SiK | 56.99 | 44.31 |
| ZnK | 13.08 | 04.37 |
| Matrix | Correction | ZAF |

TABLE 2a

| Element | Wt % | At % |
|---|---|---|
| CK | 44.82 | 65.42 |
| OK | 19.37 | 21.22 |
| SiK | 10.56 | 06.59 |
| ZnK | 25.25 | 06.77 |
| Matrix | Correction | ZAF |

TABLE 2b

| Element | Wt % | At % |
|---|---|---|
| CK | 32.07 | 62.55 |
| OK | 08.82 | 12.92 |
| SiK | 07.06 | 05.89 |
| ZnK | 52.04 | 18.65 |
| Matrix | Correction | ZAF |

Additionally, X-ray powder diffraction (XRPD) pattern was analyzed with monochromatized Cu-Kα (λ=1.54178 Å) incident radiation by a D8 Advance Bruker powder diffractometer operating at 40 kV voltage and 50 mA current.

Nitrogen sorption isotherm was measured at 77 K on a Quantachrome Instrument ASiQMVH002-5 after pretreatment by heating the samples under vacuum at 150° C. for 6 h before the measurement. For clarity, the pretreatment refers to removing loosely adsorbed molecules from the sample of the composite by heating and vacuum.

Thermal gravimetric analysis (TGA) was also carried out on a Q600 SDT thermoanalyzer (Thermal Analysis Corporation, USA) in N₂ with a heating rate of 10° C./min. Pore size distribution was calculated by DFT.

Inductively coupled plasma (ICP) was also tested by Varian 725 inductively coupled plasma emission spectrometer.

### Electrochemical Test

To prepare the anodes, 60 wt % of the Si/ZIF-8 or Si/MOF-5 prepared in this Example, 30 wt % Super P carbon black and 10 wt % sodium alginate binder were mixed in water solution to form a slurry. The slurry was cast onto copper foil and dried under a vacuum at 120° C. for 12 h. Coin cells of CR2032 type were constructed inside an argon-filled glove box using a lithium metal foil as the negative electrode and the composite positive electrode separated by polypropylene microporous separator (Celgard). The electrolyte used was 1 M LiPF₆ in ethyl carbonate (EC), diethyl carbonate (DMC) and ethyl methyl carbonate (EMC) (1:1:1 in v/v/v).

Assembled coin cells were allowed to soak overnight and then were charged and discharged galvanostatically at 50 mA/g between 0.02 and 3.0 V using a Land battery tester at ambient temperature.

The cyclic voltammetry of the Si/ZIF-8 or the Si/MOF-5 prepared in this Example were recorded with a potentiostat (CHI 760E: CH Instrumental Inc.). The range of voltage was 20 mV-3.0 V with a scan rate of 0.1 mV/s.

The electrochemical impedance spectra were measured using a potentiostat (CHI 760E: CH Instrumental Inc.) after 5 cycles at 50 mA/g. The frequency range was from 10⁻¹ to 10⁴ Hz with an applied voltage of their own.

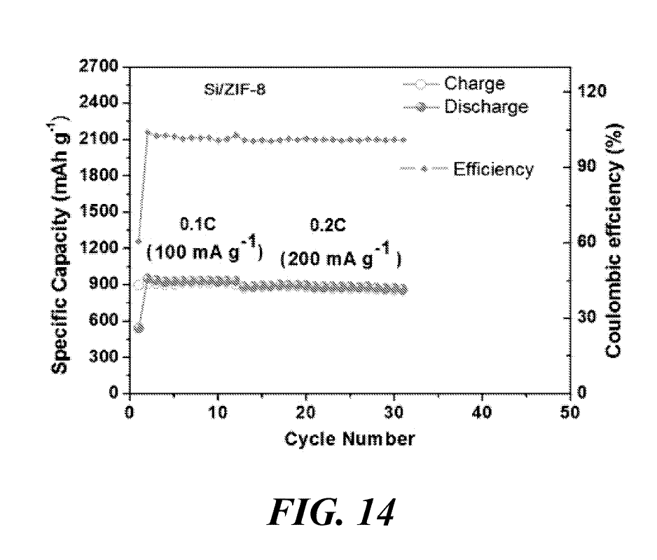

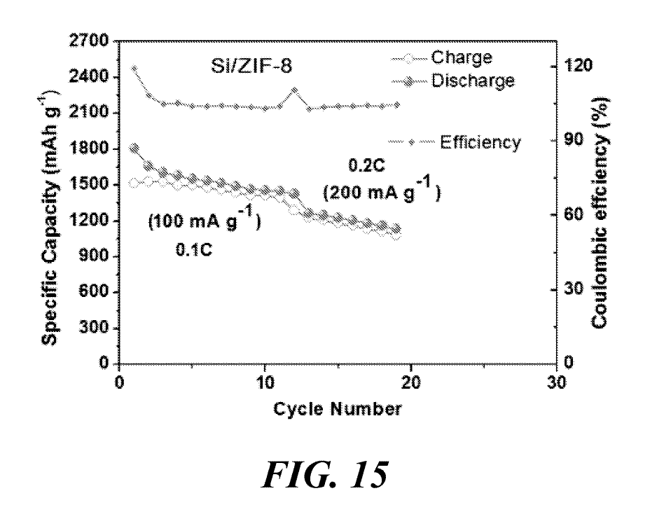

As seen in FIG. 14, the electrochemical cycle tests of the Si/ZIF-8 prepared in this Example shows the cell giving a stable capacity at 920 mAh/g at 0.1 C and 900 mAh/g at 0.2 C. Moreover, the columbic efficiency was observed to be constant over about 30 cycles and close to 100%. As seen in FIG. 15, the electrochemical cycle tests of the Si/MOF-5 prepared in this Example shows the cell giving a relatively stable capacity at 1500 mAh/g at 0.1 C and 1200 mAh/g at 0.2 C; the columbic efficiency was observed to be constant over cycles and close to 100%.

### Example 3b

### Synthesis, Characterization and Use of Si/ZIF-8 Composites

This Example demonstrates the synthesis, characterization and use of Si/ZIF-8 encapsulating silicon.

### Synthesis

Reactions were carried out in a ball mill using a 80 mL stainless steel grinding jar with five 10 mm steel balls. A solid mixture of zinc oxide (ZnO, 0.814 g, 10 mmol), nano Si (0.14 g, 5 mmol), 2-methylimidazole (1.6422 g, 20 mmol) and 1 mL methanol was placed into the jar and ground at high speed for 30 min. The products were washed with methanol (30 mL) for three times and dried at 85° C. The resulting Si/ZIF-8 was transferred to a tube furnace and was heat-treated at target temperatures (700° C.) for 1 h under nitrogen with a heating rate of 5° C. min⁻¹ to pyrolyze the nanocrystals. The materials were then cooled down to room temperature.

The resulting carbonized composite is referred to as Si/ZIF-8-700N. It should generally be understood that “700N” denotes a sample heated at 700° C. for 1 h under nitrogen.

### Characterization

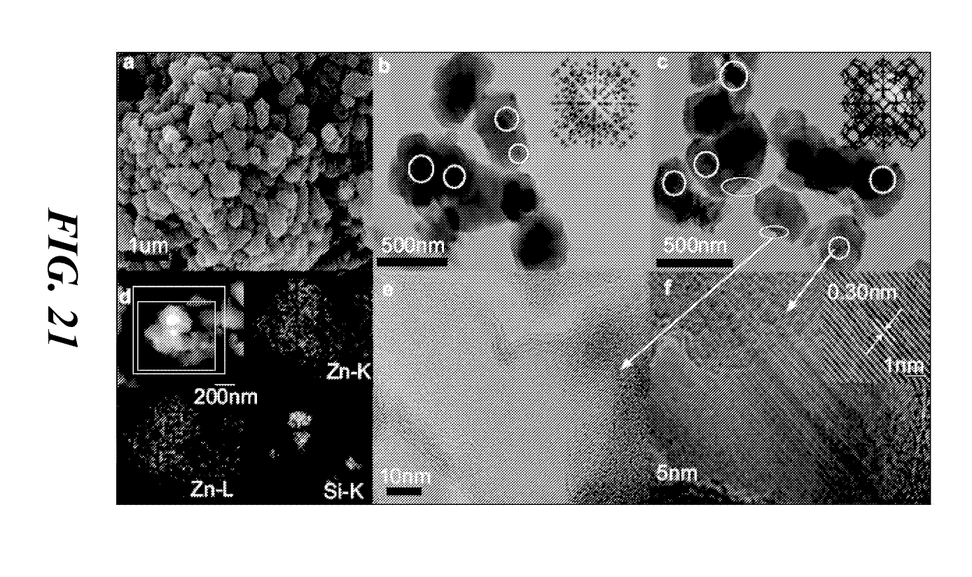

Samples of (i) Si/ZIF-8-700N; (ii) Si; (iii) Si/ZIF-8; and (iv) a control ZIF-8 were analyzed by X-ray powder diffraction according to the procedure set forth in Example 3a above. See FIG. 20(a).

Si/ZIF-8-700N was also analyzed by XPS according to the procedure set forth in Example 3a above. FIG. 20(b) is a XPS spectrum that shows the presence of zinc in the carbonized composite.

Nitrogen sorption isotherms for Si/ZIF-8, before and after carbonization, were also measured according to the procedure set forth in Example 3a above. FIG. 20(c) depicts the nitrogen sorption isotherm for Si/ZIF-8, and FIG. 20(d) depicts the nitrogen sorption isotherm for Si-ZIF-8-700N. The Si/ZIF-8 composites, before and after carbonization, were observed to be porous.

SEM was performed on the Si/ZIF-8-700N according to the procedure set forth in Example 3a above. See FIG. 21(a).

Transmission electron microscopy (TEM) was also performed on Si/ZIF, before and after carbonization. See FIGS. 21(b) and 21(c). When the TEM images of FIGS. 21(b) and 21(c) are compared, it was observed that ZIF-8 converted to amorphous carbon with monodispersed zinc ions after pyrolysis. High-resolution transmission electron microscopy (HRTEM) was also performed to further examine the edges of a Si-ZIF-8-700N composite as shown in the HRTEM image of FIG. 21(e), and the center of a Si-ZIF-8-700N composite as shown in the HRTEM image of FIG. 21(f). It should be understood that the image in FIG. 21(e) is an enlargement of the area in one of the ovals shown in the image in FIG. 21(c), and the image in FIG. 21(f) is an enlargement of the area in one of the circles shown in the image of in FIG. 21(c).

Elemental mapping of Si/ZIF-8-700N for zinc and silicon was also performed by energy-dispersive X-ray spectroscopy (EDS). With reference to FIG. 21(d), the image in the top, left quadrant depicts an exemplary Si/ZIF-8-700N composite. The image in the top, right quadrant labeled “Zn-K” and the image in the bottom, left quadrant labeled “Zn-L” of FIG. 21(d) depict the presence of zinc. These images show that the zinc was present in the entire composite, since the areas in which zinc were present in the images of the top, right and bottom, left quadrants corresponded to the shape of the composite as seen in the image of the top, left quadrant. The image in the bottom, right quadrant labeled “Si-K” of FIG. 21(d) depicts the presence of silicon. This image shows that silicon was found in the center of the composite as seen in the image of the top, left quadrant. Thus, the elemental mapping of Si/ZIF-8-700N in the images of FIG. 21(d) reveals the structure of a carbonized composite in which zinc is uniformly dispersed around silicon.

### Electrochemical Test

An anode was prepared using Si/ZIF-8-700N according to the procedure set forth in Example 3a above.

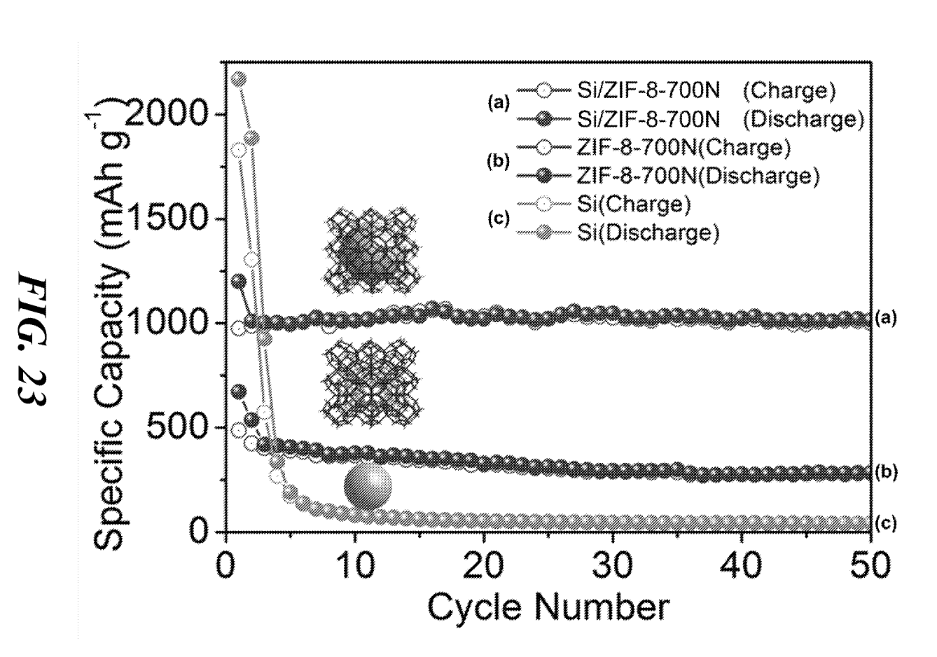

The cyclic voltammetry and electrochemical impedance of Si/ZIF-8-700N prepared in this Example were measured in accordance with the procedure set forth in Example 3a above. See FIGS. 22(a)-(f) and 23.

For the cyclic voltammetry measures on Si/ZIF-8-700N as shown in FIG. 22(c), the voltage range was 20 mV to 3.0 V at a scan rate of 0.1 mV/s. The initial point corresponded to the open-circuit voltage of the cell.

For the discharge capacity graphs taken at various current densities as shown in FIG. 22(d), the cells were cycled for 10 times at a current density of 50 mA/g before the test, and the current density varied from 200 to 3200 mA/g.

For the electrochemical impedance plots for Si/ZIF-8-700N and nano Si as shown in FIG. 22(e), the plots were obtained after four cycles. FIG. 22(e) shows that Si/ZIF-8-700N has a lower resistance than nano Si.

FIG. 23 compares the cycle-life performance of Si/ZIF-8 before and after carbonization, and pure nano Si. As seen in FIG. 23, Si/ZIF-8-700N was observed to have the highest capacity and cycling stability. Further, the effect of carbonizing Si/ZIF-8 had synergistic effects with respect to capacity and stability when compared to using Si alone or Si/ZIF-8 (without carbonization).

### Example 4

### Synthesis, Characterization and Use of Sn/MOF Composite

This Example demonstrates the synthesis, characterization and use of the following MOF encapsulating tin (Sn/MOF composite): Sn/ZIF-8.

### Synthesis

Zinc oxide, 2-methyl imidazole and tin (Sn) are combined in a steel tank, with five steel balls, and the contents were milled at high speed. Then, 500 μL methanol is added into the tank, and the contents are milled for another 15 min. The resulting products are washed with methanol (30 mL) for three times and dried.

### Characterization

The structure and morphology the product are characterized by X-ray powder diffraction, taken using monochromatized Cu-Kα (λ=1.54178 Å) incident radiation by a D8 Advance Bruker powder diffractometer operating at 40 kV voltage and 50 mA current.

### Electrochemical Test

To prepare the anodes, 60 wt % of the Sn/MOF composite prepared according to the procedure in this Example, 30 wt % Super P carbon black, and 10 wt % CMC binder are mixed in water to form a slurry. The slurry is cast onto copper foil and dried under a vacuum. Coin cells of CR2032 type are constructed inside an argon-filled glove box using a lithium metal foil as the negative electrode and the composite positive electrode separated by polypropylene microporous separator (Celgard). The electrolyte is 1 M LiPF₆ in ethyl carbonate (EC) and diethyl carbonate (DMC) and EMC Ethyl methyl carbonate (1:1:1 in v/v).

Assembled coin cells are soaked overnight and then charged and discharged galvanostatically at 50 mA/g between 0.02 and 3.0 V using a Land battery tester at ambient temperature.

1. An electrode material for use in a lithium ion battery, comprising:
a calcined or carbonized composite, wherein the composite comprises a plurality of metal oxide particles dispersed in a carbon matrix having one or more pores, wherein sulfur, silicon or tin occupies at least a portion of the one or more pores in the carbon matrix; and
wherein the electrode material has a discharge capacity over an initial 50 cycles of at least 900 mAh/g at room temperature when discharged from 3.0 V to 20 mV after the material is activated in the first cycle through a charge to 20 mV at a rate of 0.1 mV/s.

2. The electrode material of claim 1, wherein the plurality of metal oxide particles are uniformly dispersed in a carbon matrix having one or more pores.

3. The electrode material of claim 1, wherein the calcined or carbonized composite is obtained by a method comprising:
mechanochemically processing (i) one or more organic linking compounds, (ii) one or more metal compounds, and (iii) sulfur, silicon or tin to produce a metal organic framework (MOF) composite; and
calcining or carbonizing the MOF composite to produce the calcined or carbonized composite.

4. The electrode material of claim 3, wherein the one or more organic linking compounds are independently:
an aryl with at least one phenyl ring substituted with at least one —COOH moiety, or
a heteroaryl with at least pyridyl ring substituted with at least one —COOH moiety.

5. The electrode material of claim 3, wherein the one or more organic linking compounds are independently an aromatic ring system with at least one phenyl ring optionally substituted with alkyl, or an aromatic ring system coordinating to or chelating with a tetrahedral atom, or forming a tetrahedral group or cluster.

6. The electrode material of claim 3, wherein the MOF is a zeolitic imidazolate framework (ZIF).

7. The electrode material of claim 3, wherein the one or more organic linking compounds are independently:
a monocyclic five-membered heteroaryl having at least two nitrogen atoms, wherein two of the nitrogen atoms are configured in the 1- and 3-positions of the monocyclic five-membered ring, or
a bicyclic ring system made up of at least one five-membered ring having at least two nitrogen atoms, wherein two of the nitrogen atoms are configured in the 1- and 3-positions of the five-membered ring.

8. The electrode material of claim 3, wherein the MOF 15 ZIF-8, HKUST-1, MIL-53, NH₂-MIL-53, or MOF-5.

9. The electrode material of claim 3, wherein the one or more metal compounds independently comprise Mg²⁺, Ca²⁺, Sr²⁺, Ba²⁺, Sc²⁺, Y³⁺, Ti⁴⁺, Zr⁴⁺, Hf⁴⁺, V⁴⁺, V³⁺, V²⁺, Nb³⁺, Ta³⁺, Cr³⁺, Mo³⁺, W³⁺, Mn³⁺, Mn²⁺, Re³⁺, Re²⁺, Fe³⁺, Fe³⁺, Ru³⁺, Ru²⁺, Os³⁺, Os²⁺, Co³⁺, Co²⁺, Rh²⁺, Rh⁺, Ir²⁺, Ir⁺, Ni²⁺, Ni⁺, Pd²⁺, Pd⁺, Pt²⁺, Pt⁺, Cu²⁺, Cu⁺, Ag⁺, Au⁺, Zn²⁺, Cd²⁺, Hg²⁺, Al³⁺, Ga³⁺, In³⁺, Tl³⁺, Si⁴⁺, Si²⁺, Ge⁴⁺, Ge²⁺, Sn⁴⁺, Sn²⁺, Pb⁴⁺, Pb²⁺, As⁵⁺, As³⁺, As⁺, Sb⁵⁺, Sb³⁺, Sb⁺, Bi⁵⁺, Bi³⁺, or Bi⁺.

10. The electrode material of claim 1, wherein the calcined or carbonized composite comprises sulfur, and the electrode material is a cathode material.

11. The electrode material of claim 1, wherein the calcined or carbonized composite comprises silicon or tin, and the electrode material is an anode material.

12. A lithium ion battery comprising:
a cathode;
an anode; and
a separator between the cathode and anode,
wherein the cathode comprises the cathode material of claim 10.

13. A composite comprising a metal-organic framework (MOF) having one or more pores, wherein:
sulfur, silicon or tin occupies at least a portion of the one or more pores,
the composite has an average size less than 10 microns, and
the composite has an X-ray powder diffraction (XRPD) pattern wherein the peak corresponding to sulfur, silicon or tin has an intensity less than 100 (a.u.).

14. The composite of claim 13, wherein the MOF is a zeolitic imidazolate framework (ZIF), and the composite has an average size less than 500 nm.

15. The composite of claim 13, wherein the open framework is ZIF-8, HKUST-1, MIL-53, NH₂-MIL-53, or MOF-5.

16. The composite of claim 13, wherein the open framework is ZIF-8, and the composite has an average discharge capacity over an initial 10 cycles of: (i) at least 900 mAh/g at 0.1 C; and (ii) at least 700 mAh/g at 0.5 C, or both (i) and (ii).

17. The composite of claim 13, wherein the composite has one or more of the following properties (A)-(C):
(A) a decay rate at 0.5 C of less than 0.1% per cycle; or
(B) an average retention rate after 200 cycles of at least 70%; or
(C) an average coulombic efficiency over 30 cycles of at least 80%.

18. A method for producing a composite, comprising mechanochemically processing (i) one or more organic linking compounds, (ii) one or more metal compounds, and (iii) sulfur, silicon or tin to produce the composite, wherein the composite comprises a metal-organic framework (MOF) produced from the one or more organic linking compounds and the one or more metal compounds, and
wherein the open framework has one or more pores, and
wherein the sulfur, silicon or tin occupies at least a portion of the one or more pores.

19. The method of claim 18, wherein the composite has an X-ray powder diffraction (XRPD) pattern wherein the peak corresponding to sulfur, silicon or tin has an intensity less than 100 (a.u.).

20. The method of claim 18, wherein the one or more organic linking compounds are independently:
an aryl with at least one phenyl ring substituted with at least one —COOH moiety, or
a heteroaryl with at least pyridyl ring substituted with at least one —COOH moiety.

21. The method of claim 18, wherein the one or more organic linking compounds are independently an aromatic ring system with at least one phenyl ring optionally substituted with alkyl, or an aromatic ring system coordinating to or chelating with a tetrahedral atom, or forming a tetrahedral group or cluster.

22. The method of claim 18, wherein the MOF is a zeolitic imidazolate framework (ZIF).

23. The method of claim 22, wherein the one or more organic linking compounds are independently:
a monocyclic five-membered heteroaryl having at least two nitrogen atoms, wherein two of the nitrogen atoms are configured in the 1- and 3-positions of the monocyclic five-membered ring, or
a bicyclic ring system made up of at least one five-membered ring having at least two nitrogen atoms, wherein two of the nitrogen atoms are configured in the 1- and 3-positions of the five-membered ring.

24. The method of claim 18, wherein the MOF is ZIF-8, HKUST-1, MIL-53, NH₂-MIL-53, or MOF-5.

25. The method of claim 18, wherein the one or more metal compounds independently comprise Mg²⁺, Ca²⁺, Sr²⁺, Ba²⁺, Sc³⁺, Y³⁺, Ti⁴⁺, Zr⁴⁺, Hf⁴⁺, V⁴⁺, V³⁺, V²⁺, Nb³⁺, Ta³⁺, Cr³⁺, Mo³⁺, W³⁺, Mn³⁺, Mn²⁺, Re³⁺, Re²⁺, Fe³⁺, Fe³⁺, Ru³⁺, Ru²⁺, Os³⁺, Os²⁺, Co³⁺, Co²⁺, Rh²⁺, Rh⁺, Ir²⁺, Ir⁺, Ni²⁺, Ni⁺, Pd²⁺, Pd⁺, Pt²⁺, Pt⁺, Cu²⁺, Cu⁺, Ag⁺, Au⁺, Zn²⁺, Cd²⁺, Hg²⁺, Al³⁺, Ga³⁺, In³⁺, Tl³⁺, Si⁴⁺, Si²⁺, Ge⁴⁺, Ge²⁺, Sn⁴⁺, Sn²⁺, Pb⁴⁺, Pb²⁺, As⁵⁺, As³⁺, As⁺, Sb⁵⁺, Sb³⁺, Sb⁺, Bi⁵⁺, Bi³⁺, or Bi⁺.

26. The method of claim 18, wherein sulfur is used to produce the composite.

27. The method of claim 18, wherein silicon or tin is used to produce the composite.

28. The method of claim 18, further comprising calcining or carbonizing the composite.

29. A composite produced according to claim 18.

30. An electrode, comprising:
a composite of claim 13;
carbonaceous material; and
binder.

31. The electrode of claim 30, wherein the electrode is a cathode, and the composite comprises sulfur.

32. The electrode of claim 30, wherein the electrode is an anode, and the composite comprises silicon or tin.

33. A battery, comprising:
a cathode of claim 30; and
lithium ions.

34. A lithium ion battery comprising:
a cathode;
an anode; and
a separator between the cathode and anode,
wherein the anode comprises the anode material of claim 11.

35. A battery, comprising:
an anode of claim 31; and
lithium ions.
